(19) United States
(12) Patent Application Publication
(10) Pub. No.: US 2023/0366849 A1
(43) Pub. Date: Nov. 16, 2023

(54) OXYGEN INSENSITIVE AMPEROMETRIC BIOSENSORS

(71) Applicant: TECHNION RESEARCH AND DEVELOPMENT FOUNDATION LTD., Haifa (IL)

(72) Inventors: Omer YEHEZKELI, Kiiyat Tivon (IL); Roy COHEN, Tel Aviv (IL); Yifat COHEN, Yokneam Ilit (IL); Dina MUKAH, Haifa (IL)

(21) Appl. No.: 18/044,458

(22) PCT Filed: Sep. 2, 2021
(86) PCT No.: PCT/IL2021/051078

§ 371 Date: Mar. 8, 2023

Related U.S. Application Data
(60) Provisional application No. 63/075,423, filed on Sep. 8, 2020.

(51) Int. Cl. G01N 27/327

(52) U.S. Cl. CPC G01N 27/3278

(57) ABSTRACT

The invention disclosed herein concerns an amperometric enzyme-based biosensor which exhibits high accuracy, high bioelectrocatalytic currents, linear response, low overpotentials and stability.

### TECHNOLOGICAL FIELD

The invention generally concerns amperometric biosensors for determining presence of analytes of medical importance.

### BACKGROUND

Diabetes has become one of the major health issues of modern times. According to the 2017 National Diabetes Statistics Report, 9.4% of the US population displays diabetes symptoms. This widespread disease is closely related to other health threats such as obesity and hypertension and therefore, ways of limiting its effect must be developed. Once symptoms are observed, strict control of the patient's glucose levels is necessary. Healthy glucose levels range between 70 mg/dL and 120 mg/dL, while glucose levels of diabetes patients exceed these values due to under regulation of the pancreas. Research has shown that interstitial fluid glucose levels are similar to blood glucose concentrations. Therefore, devices that can continuously monitor glucose content accurately in real-time, skipping the need to repeatedly prick the patient's finger, can improve dramatically the patients' quality of life.

The first generation of glucose monitoring devices can indirectly measure glucose levels using glucose oxidase as a biocatalyst. Although the accuracy of such devices was limited due to indirect amperometric signals, GOx has been considered for many years as the standard enzyme for glucose sensing. GOx oxidizes glucose to gluconic acid while reducing oxygen to hydrogen peroxide. By monitoring oxygen depletion or hydrogen peroxide oxidation or reduction, an indirect sensor can be fabricated. The homodimer enzyme consists of a flavin adenine dinucleotide (FAD) cofactor that enables the redox reaction involving glucose and atmospheric oxygen. The FAD cofactor is embedded in the protein shell (approximately 1.3 nm deep), meaning that direct electrical contact between the enzyme and the electrode is not feasible. The establishment of electrical communication between an enzyme and an electrode is a crucial step for highly selective direct glucose monitoring. Different methods have been developed to overcome this “electrical insulation” phenomenon by using redox mediators or redox hydrogels. Inorganic redox molecules, e.g. ferrocene or osmium bi-pyridinium complexes, were bonded to the polymer backbone, enabling the transfer of electrons from the entrapped enzymes to the electrode. In nature, the enzymatic reaction rate of GOx is approximately 600 s⁻¹. To eliminate any oxygen interference with the biosensor, the electron transfer rate must upend the natural rates. Different approaches have been developed to facilitate high turnover rates, which at best reach about ten times those found in nature. For example, Apo GOx, an enzyme lacking the FAD cofactor, was reconstituted on synthetically modified FAD that was bonded to a redox mediator or gold nanoparticle (Au NP). Those methodologies have introduced an interesting approach, nevertheless, they were not suitable for application due to low stability, high production costs, and high overpotentials.

Other enzymes were also tested as possible bio-electrocatalysts for the fabrication of glucose biosensing devices. For example, cellobiose dehydrogenase (CDH), an enzyme that consists of two domains—a large catalytic FAD-containing domain and a small cytochrome b-containing domain—that are connected by a polypeptide linker. CDH was immobilized on electrodes to form a direct or mediated electron transfer-based biosensor. PQQ-dependent glucose dehydrogenase (GDH) was thought to hold great promise for future sensing devices: it oxidizes glucose, yet the oxygen cannot act as an electron acceptor and so does not interfere with the electron transfer process toward the electrode. Nevertheless, PQQ-dependent GDH exhibits low selectivity that limits its applicability. Other enzymes, e.g. ß-nicotinamide adenine-dinucleotide (NAD) or NADP-dependent GDH, were explored for use in amperometric biosensors devices, but methods for integrating the diffusional NAD/NADP limit the construction of integrated amperometric biosensors. Although FAD-dependent GDH was discovered more than 50 years ago, it has only recently become the leading enzyme for glucose sensing applications.

FAD-GDH encoding genes from a variety of origins were cloned and overexpressed in yeast or E. coli. While oxygen acts as an electron acceptor in the GOx biocatalytic reaction, FAD-GDH can reduce a variety of electron acceptors e.g., dichlorophenol indo-phenol (DCPIP) or quinones. Since oxygen cannot act as an electron acceptor, applications based on FAD-GDH hold great promise. Efforts have been made in recent years to develop efficient biosensors or biofuel cells (BFCs) based on FAD-GDH. For example, redox-active Os-based polyvinylimidazole polymer or linear-poly-ethylenimine-naphthoquinone were used to crosslink or entrap the enzyme on the electrode surface and facilitate a mediated electron transfer (MET) process. Implementing a different approach, FAD-GDH was modified with electro-polymerized aniline units and the electro-polymerized enzyme/AuNPs composite was used for glucose sensing and the construction of a BFC device. Moreover, using a unique bioengineering method, the β subunit of B. cepacia FAD-GDH was replaced with a minimal cytochrome c (Cyt c) sequence to yield an improved direct electron transfer process with the electrode. Although many advances have been achieved, the high number of patients with diabetic symptoms require simple, stable, cheap, and sustainable methods to construct amperometric glucose biosensors.

### GENERAL DESCRIPTION

The inventors of the technology disclosed herein have developed an amperometric enzyme-based biosensor which exhibits high accuracy, high bioelectrocatalytic currents, good linear response, low overpotentials and great stability.

Biosensors according to the invention can be structured to detect any analyte of biological or medical interest. To demonstrate the effectiveness of the technology, a glucose biosensor and a lactate biosensor, each utilizing a separately suitable enzyme, were developed. In these exemplary systems, the enzyme was co-entrapped in a stabilizing matrix such as polydopamine layer or agarose, with dichlorophenol, (DCPIP) or dichloronaphthoquinone or thionine as redox charge mediators. To structure biosensors for other analytes, both the enzyme and the redox charge mediators may be varied.

In its most general aspect, the technology disclosed herein provides an oxygen-passive (oxygen insensitive) biosensor device comprising a surface region of a carbon allotrope and a matrix material layer associated with said surface region, the matrix material layer entrapping at least one enzyme and at least one redox charge mediator.

The invention further provides a biosensor device comprising at least one electrode (or electrode assembly comprising both a cathode and an anode) having a surface region composed of at least one carbon allotrope, the surface region being associated with a matrix material entrapping at least one enzyme and at least one redox charge mediator.

The invention further provides a bioanode or a biocathode comprising at least one electrode (or electrode assembly comprising both a cathode and an anode), the anode electrode (in the case of a bioanode) or the cathode electrode (in the case of the biocathode) having a surface region comprising or consisting at least one carbon allotrope, the surface region being associated with a matrix material entrapping at least one enzyme and at least one redox charge mediator.

As used herein, the biosensor of the invention is an amperometric device for measuring an electric current as a function of a potential difference between a working electrode and a reference electrode. The measurement of the electric current can be carried out by means known in the art, particularly known for amperometric techniques, e.g., by potential sweep voltammetry which may be linear, cyclic, or pulse voltammetry or else of a potential step type, such as chronoamperometry. Employing such amperometric techniques requires a sensor construction that comprises an electrode assembly, namely a working electrode, a reference electrode and optionally a counter or auxiliary electrode. In a design according to the invention, the enzyme and a redox mediator are confined to a very thin molecular film (layer) of the matrix material at the electrode, e.g., anode, carbon allotrope surface, by electrostatic assembly, to leverage the electrocatalytic effect of the allotrope to reduce the oxidation overpotential of the electrode reaction or for the direct electron transport to the enzyme. An electric current that is generated at the electrode's surface when a redox reaction, directly related to the enzymatic reaction with a substrate, e.g., an analyte, is produced, the signal can be correlated with the analyte's concentration.

The reference electrode is an electrode of which the potential is constant, and which makes it possible to impose a precisely defined potential on the working electrode. The reference electrode may be an Ag/AgCl electrode. The counter electrode, if present, may be fabricated of an inert material, as known in the art.

In some embodiments, the biosensor is a bioanode or a biocathode.

The biosensor of the invention is said to be oxygen-passive, namely insensitive to oxygen. When measurements were carried out under oxygen-rich or oxygen-containing conditions (e.g. atmospheric oxygen), the effect of the oxygen on the signal generated was negligible.

As stated herein, the biosensor or device of the invention is constructed of a matrix material entrapping at least one enzyme and at least one redox charge mediator, wherein the matrix material is associated to a surface region of a carbon allotrope. The “matrix material” used in devices of the invention is selected to stabilize and shelter the enzyme from environmental effects that may influence its stability and function, prevent unfolding of the enzyme and generally act to encapsulate the reacting entities as disclosed. The matrix material is typically a polymeric material or a polysaccharide. Non-limiting examples of matrix materials according to the invention include polydopamine, agarose, Nafion, chitosan, polyethyelenimine (PEI), polyvinylpyridine (PVPy) and others.

In some embodiments, the matrix material is selected from polydopamine, agarose, Nafion, chitosan, polyethyelenimine (PEI), polyvinylpyridine (PVPy).

In some embodiments, the matrix material is polydopamine, or agarose, or Nafion, or chitosan, or polyethyelenimine (PEI), or polyvinylpyridine (PVPy).

In some embodiments, the matrix material is polydopamine or agarose.

In some embodiments, the matrix material is polydopamine.

In some embodiments, the matrix material is agarose.

Thus, in some embodiments, the oxygen-passive (oxygen insensitive) biosensor comprises a surface region of a carbon allotrope and polydopamine as a matrix material layer, which is associated with said surface region, the polydopamine matrix material layer entrapping at least one enzyme and at least one redox charge mediator.

In other embodiments, the oxygen-passive (oxygen insensitive) biosensor comprises a surface region of a carbon allotrope and agarose as a matrix material layer, which is associated with said surface region, the agarose matrix material layer entrapping at least one enzyme and at least one redox charge mediator.

The matrix material, as defined, forms a layer on the surface of the carbon allotrope material and entraps the at least one enzyme and at least one redox charge mediator. The matrix material matrix may be fabricated by reacting a matrix material precursor in the presence of the enzyme and the redox charge mediator or by allowing a mixture of the three components to form a layer on the carbon allotrope material. In some embodiments, the redox charge mediator may be chemically associated to the allotrope material, e.g. using diazonium chemistries or EDC/NHS chemistries, with the matrix material entrapping the enzyme forming a film on the carbon allotrope or the carbon allotrope directly. Notwithstanding the method for fabricating the biosensor, both the enzyme and the redox charge mediator are entrapped, contained, confined or held within a thin film of the matrix material material.

The carbon allotrope is typically a carbonaceous material comprising mainly carbon atoms and having a high surface area. The carbon allotrope may be any such material known in the art, and may be selected from carbon nanotubes, graphite, carbon paste, fullerenes, carbon nanobuds, amorphous carbon, glassy carbon, lonsdaleite and carbon nanofoam. In cases where the electrode is carbon-based, e.g., a glassy carbon electrode, GCE, the carbon allotrope may be of a different carbon material.

In some embodiments, the electrode is GCE and the carbon allotrope is carbon nanotube, e.g., multi-walled CNTs (MWCNT).

The carbon allotrope used in accordance with the invention is selected based on its surface area. A suitable allotrope may have a high surface area as compared to its weight or volume. In some embodiments, the allotrope is selected to have a surface area between 120 and 1315 m²/gr.

In some embodiments, the surface area is up to 1315 m²/gr.

In some embodiments, the carbon allotrope is a carbon nanotube (CNT). The CNT may be selected from high surface area CNTs, including for example single-walled CNT (SWCNT), MWCNT and others having a surface area as defined above. In some embodiments, the CNT is MWCNT.

In some embodiments, the carbon allotrope is a carbon paste, carbon fibers, carbon dots and graphene.

In some embodiments, the carbon allotrope is a carbon paste, namely a mixture of carbon allotropes, mainly graphite and at least one pasting material.

An electron-transfer mediator or redox charge mediator is used to regain the original charge of the enzyme active site to its original state following interaction with a substrate, namely the analyte to be detected. As such, the redox charge mediator may be any such material known in the art and may be selected based on the enzyme utilized. A suitable redox charge mediator is one having a redox potential that is more positive than the redox potential of the enzyme; in the case, for example, of FAD-GDH- more positive than the redox potential of FAD, e.g., −0.48V. As used herein, the term “a redox potential that is more positive than the redox potential of the enzyme” refers to a measure of ease with which a molecule will accept electrons, which means that the more positive the redox potential, the more readily a molecule is reduced. The redox charge mediator is selected to rapidly cycle between its oxidized and reduced states in the process of moving charge between the enzyme and the electrode carbon allotrope surface. In doing so, the charge mediator must remain stable in both oxidation states for the mediation to continue and the device to be reusable.

Various redox charge mediators may be utilized in devices of the invention. These include, without limitation, benzyl viologen, indigo disulfonate, methylene blue, 2,5-dihydroxybenzoquinone, ferrocenecarboxaldehyde, ferrocenmethanol, thionine, dichloronaphtoquinone (DCNQ) and dichlorophenol indo-phenol (DCPIP). Other naphtoquinone derivatives may also serve as efficient redox mediators. These may include naphotoquinones that are substituted with halids, sulfonate group(s), methyl group(s), methoxy group(s), ester group(s), aldehyde group(s) and others.

In some embodiments, the redox charge mediator is a naphthoquinone derivative, such as dichloronaphtoquinone (DCNQ) or dichlorophenol indo-phenol (DCPIP).

In some embodiments, the redox charge mediator is thionine.

Biosensors of the invention may be used to detect or measure certain analytes of choice. By changing the enzyme used in the construction of the device, anaylte-specific biosensors may be fabricated. Non-limiting examples of enzymes include glucose dehydrogenase (GDH), lactate dehydrogenase (LDH), lactose dehydrogenase, alcohol dehydrogenase, fructose dehydrogenase, glucose-6-phosphate dehydrogenase, and others.

In some embodiments, the biosensor of the invention is fabricated as a glucose sensor for measuring glucose using glucose dehydrogenase (GDH). Three GDH types may be utilized in sensors of the invention, each differing in the coenzyme used: nicotinamide-dependent GDH, pyrroloquinoline quinone (PQQ-GDH) and flavin adenine dinucleotide (FAD-dependent GDH, FAD-GDH).

In some embodiments, the enzyme is FAD-GDH, which is optionally derived in pure or mixture form from a variety of microorganisms. In some embodiments, the FAD-GDH is derived from the genus Aspergillus, from the genus Penicillium, from Filamentous fungi of the Moraceae and the like.

In some embodiments, the FAD-GDH is derived from a microorganism selected from any one of the following genera Aspergillus, Trichoderma, Neurospora, Monascus, Fusarium, Saccharomyces, Pichia, Candida, Schizosaccharomyces Cryptococcus, Schizophyllum, Mucor, Absidia, Actinomucor, Colletotrichum, Circinella, Talaromyces emersonii and Arthrinium.

Thus, the invention further provides a device or a biosensor or a glucometer for detecting presence and amount of glucose in a sample (diagnostic sample, blood sample, sweat, interstitial fluids and others), the device comprising an electrode (typically an anode) having a surface region comprising or consisting at least one carbon allotrope, e.g., MWCNT, the surface region being associated with a matrix material such as polydopamine, entrapping FAD-GDH and at least one redox charge mediator, as defined herein.

In some embodiments, the redox charge mediator is dichloronaphtoquinone (DCNQ) or dichlorophenol indo-phenol (DCPIP). In some embodiments, the device implements FAD-GDH and DCNQ; in other embodiments, the device implement FAD-GDH and DCPIP.

In some embodiments, the device or a biosensor or a glucometer for detecting presence and amount of glucose in a sample (diagnostic sample, blood sample, sweat, interstitial fluids and others), the device comprises an anode having a surface region comprising or consisting at least one MWCNT (a plurality), the surface region being associated with polydopamine, entrapping FAD-GDH and at least one redox charge mediator (a plurality) being dichloronaphtoquinone (DCNQ) and/or dichlorophenol indo-phenol (DCPIP).

In some embodiments, the biosensor of the invention is fabricated as a lactate sensor for measuring lactate in a sample (e.g., blood, sweat, intestatial fluids) using lactate dehydrogenase (LDH). In some embodiments, the LDH is a flavin mononucleotide (FMN)-dependent L-LDH.

In some embodiments, the enzyme is a NAD/PQQ-dependent lactate dehydrogenase, lactate 2-monooxygenase or lactate oxidase.

The invention thus further provides a device or a biosensor for detecting presence and amount of lactate in a sample, the device comprising an electrode (typically an anode) having a surface region comprising or consisting at least one carbon allotrope, e.g., MWCNT, the surface region being associated with a matrix material entrapping lactate dehydrogenase (LDH) and at least one redox charge mediator, as defined herein.

In some embodiments, the matrix material may be polydopamine or agarose. In some embodiments, the at least one redox charge mediator is optionally thionine.

In some embodiments, in a device or a biosensor for detecting presence and amount of lactate in a sample, the device comprises an anode having a surface region comprising or consisting at least one MWCNT, the surface region being associated with agarose as a matrix material, entrapping lactate dehydrogenase (LDH) and thionine as a redox charge mediator.

The invention further provides a multi-sensing device for determining presence of two or more analytes, e.g., glucose and lactate, wherein the device comprises at least one analyte-specific enzyme or enzymes, as disclosed herein. Such devices of the invention, as other devices enabling detection of a single analyte, can be utilized to provide a point of care data for physicians in the clinic or can be utilized for continuous monitoring of these biomarkers using a patch on the patient skin or in the interstitial fluids, as further detailed herein.

Thus, for example, a device of the invention may comprise two independent sensors, each being configured to detect presence of a different analyte, or a combined sensor having an anode with a surface region comprising or consisting at least one MWCNT, or any carbon allotrope equivalent thereof, a matrix material as defined herein, an analyte specific enzyme, as disclosed, and a redox charge mediator, which may be a single material or a combination of different materials.

In an amperometric device according to the invention, the analyte undergoes or is involved in a redox reaction that can be followed by measuring the current in the device. The analyte changes its oxidation state at the functional electrode, e.g., the anode. The current is measured as a function of time, when the electrode is driven at an appropriate constant potential. The analyte, being the substrate of the enzyme used in the device, e.g., glucose, lactate or others, diffuses through the matrix material and reaches the entrapped enzyme, which is at an effective distance from the electrode surface sufficient to induce a current change. In the presence of the enzyme, the analyte interacts with the enzyme and the current varies in a way that is proportional to the amount of the resulting electro-oxidized/reduced species, which in turn may be directly or inversely proportional to the analyte concentration, depending on the assay format. In the presence of the redox charge mediator, the enzyme generates bioelectrocatalytic current which is transferred to the electrode via the redox mediator and activity is regained.

The biosensor or device of the invention may thus be implemented in a sensing unit, the sensing unit comprising:
an electrode assembly composed of at least one working electrode and at least one reference electrode, said working electrode having an active surface of at least one carbon allotrope and a film of a matrix material disposed thereon, the film of the matrix material comprising, entrapping or holding an (one or more) enzyme and a (one or more) redox charge mediator,
a measuring circuit for measuring a change in the current generated by the working electrode at a constant potential, as a function of time, and
a connection means to connect said electrodes to the measuring circuit, the device being configured and operable for functioning when in contact with a medium to be analyzed.

The unit may be fabricated as a wearable device as disclosed herein.

Biosensors or devices of the invention may be fabricated by modifying a carbon allotrope surface region of an electrode. For example, the electrode, e.g., anode, may be first modified with a carbon allotrope such as MWCNT. The modified electrode may be subsequently dried and further modified with a mixture containing a matrix material or a precursor thereof (for example for polydopamine-using dopamine as a precursor material), the redox charge mediator, e.g., DCPIP and the enzyme, e.g., FAD-GDH. The electrode is thereafter allowed to polymerize to form a the matrix layer, e.g., a polydopamine layer entrapping the charge mediator and the enzyme.

In some embodiments, the modified electrode, e.g., bioanode, may be further optimized to achieve maximal bioelectrocatalytic currents. Optimization may be achievable, for example, by altering the amount of the enzyme or of the redox mediator, or by altering the matrix amount on the electrode.

The matrix material may be obtained by in situ polymerization of a matrix precursor in the presence of the enzyme and the charge mediator. To achieve selective and efficient polymerization, the initial mixture of precursor, charge mediator and enzyme is maintained as basic pH. Under such conditions, the precursor polymerizes, forming the matrix material film entrapping the active materials. The film formed is typically several nanometers to several micrometers in thickness and exhibits a degree of porosity that may vary from one film to another. Functional groups such as amines and thiol groups that are present on the enzyme or the charge mediator can react with the polymerized film to form covalent bonds; thereby enhancing the stability of the device.

In some embodiments, in a process for making a biosensor according to the invention, FAD-GDH and dichlorophenolindophenol, DCPIP, were entrapped in a matrix material such as polydopamine layer or an agarose layer deposited on an MWCNT-modified glassy carbon electrode, GCE.

In some embodiments, FAD-GDH and dichlorophenolindophenol, DCPIP, were entrapped in a matrix material, e.g., polydopamine layer deposited on different surfaces than GCE, such as gold disk electrodes or Toray paper.

In some embodiments, a bioanode may be used as a biosensing device for continuous analyte monitoring (e.g., continuous glucose monitoring, CGM) using a low applied bias of 0V vs. Ag/AgCl.

The device may be used for determining the presence of an analyte in a sample, e.g., for detecting blood glucose in a blood sample, or for determining the presence of an analyte in a subject's sweat. Therefore, devices of the invention may be fabricated as wearable sensors for in situ, real-time, and non-invasive monitoring of health conditions. The wearable device may be fabricated as wrist-worn devices, watches, textile embedded devices, strap-mounted devices, stickers, patches, temporary tattoos, comprising the active materials and a power source, with the ability to measure analytes such as glucose, lactate, ammonia, ethanol, and others.

The wearable device of the invention may comprise an electrode assembly composed of at least one working electrode and at least one reference electrode, said working electrode having an active surface of at least one carbon allotrope and a film of a matrix material such as polydopamine or agarose or an equivalent material thereof, as defined, disposed thereon, the film comprising, entrapping or holding an (one or more) enzyme and a (one or more) redox charge mediator. The device may further comprise:
a measuring circuit for measuring a change in the current generated by the working electrode at a constant potential, as a function of time, and
a connection means to connect said electrodes to the measuring circuit.

The wearable device is configured and operable for functioning when in contact with a medium to be analyzed, such as blood, sweat, intestatial fluids or saliva.

The device may further comprise a processor that executes instructions to measure one or more physical parameters of the user and to evaluate a medical condition of the user based on the measured physical parameters and the medical information pertaining to the user medical condition to be monitored that is stored in the memory.

Also, the device may comprise a communication interface that transmits the evaluation over a wireless communication network to the devices of one or more evaluating entities

Thus, a wearable device of the invention may comprise
an electrode assembly composed of at least one working electrode and at least one reference electrode, said working electrode having an active surface of at least one carbon allotrope and a film of a matrix material such as polydopamine or agarose disposed of thereon, the film comprising, entrapping, or holding a (one or more) enzyme and a (one or more) redox charge mediator,
a measuring circuit for measuring a change in the current generated by the working electrode at a constant potential, as a function of time,
a connection means to connect said electrodes to the measuring circuit, and optionally one or more of the following:
a memory that stores user information including medical information pertaining to a medical condition of the user to be monitored,
one or more additional sensors that monitor one or more additional or other or same physical parameters of the user,
a processor that executes instructions to measure one or more physical parameters of the user and to evaluate a medical condition of the user based on the measured physical parameters and the medical information pertaining to the user medical condition to be monitored that is stored in memory, and/or
a communication interface that transmits the evaluation over a wireless communication network to the devices of one or more evaluating entities.

A setup comprising an enzyme and a redox mediator on a carbon allotrope modified electrode can be used to fabricate a biofuel device for generating electrical power. In an exemplary device, a lactate dehydrogenase (LDH) bioanode can be further coupled with a bilirubin oxidase (BOD)-based cathode to construct a biofuel cell device generating electrical power while oxidizing lactate. For the operation of such a device, human sweat can be used, as it contains millimolar amounts of lactate. This methodology can be utilized on a variety of electrode materials.

Accordingly, a biofuel cell may be constructed by mixing the BOD enzyme with a redox mediator, such as (2,2′-azino-bis(3-ethylbenzothiazoline-6-sulfonic acid) (ABTS), and dopamine. The solution is then deposited on glassy carbon and dried at room temperature. Alternatively, the enzyme can be drop-cast on a previously deposited MWCNTs layer, dopamine ABTS layer, and enzyme. The above bioanode can reduce oxygen into water and while conjugated through an external wire to a bioanode (LDH, GDH) in a biofuel cell configuration it can be used as an electrical energy generating device (topical, in blood, or the interstitial fluids).

Thus, the invention provides:

An electrode having a surface region composed of at least one carbon allotrope associated with a layer of a matrix material, the layer entrapping at least one enzyme and at least one redox charge mediator.

A bioanode electrode having a surface region comprising or consisting at least one carbon allotrope, the surface region being associated with a matrix material entrapping at least one enzyme and at least one redox charge mediator.

In some embodiments of aspects of the invention, the carbon allotrope having a surface area between 120 and 1315 m²/gr.

In some embodiments of aspects of the invention, the carbon allotrope is selected from carbon nanotubes, graphite, carbon paste, fullerenes, carbon nanobuds, amorphous carbon, glassy carbon, lonsdaleite and carbon nanofoam.

In some embodiments of aspects of the invention, when the electrode is carbon-based, the carbon allotrope is of a different carbonaceous material.

In some embodiments of aspects of the invention, the electrode is a glassy carbon electrode (GCE) and the carbon allotrope is carbon nanotube.

In some embodiments of aspects of the invention, the carbon allotrope is a carbon nanotube (CNT).

In some embodiments of aspects of the invention, the CNT is selected from single walled CNT (SWCNT) and multiwalled CNTs (MWCNT).

In some embodiments of aspects of the invention, the CNT is MWCNT.

In some embodiments of aspects of the invention, the carbon allotrope is selected from a carbon paste, carbon fibers, carbon dots and graphene.

In some embodiments of aspects of the invention, the carbon allotrope is a carbon paste.

In some embodiments of aspects of the invention, the electrode is for use in a biosensor.

In some embodiments of aspects of the invention, a product of the invention is for use in detection of an analyte in a liquid or gaseous medium.

A biosensor device comprising at least one electrode according to various aspects and embodiments of the invention.

A biosensor device is provided which comprises at least one electrode having a surface region composed of at least one carbon allotrope, the surface region being associated with a matrix material entrapping at least one enzyme and at least one redox charge mediator.

In some embodiments of aspects of the invention, a device is configured and operable for detecting an analyte in a liquid or gaseous medium.

In some embodiments of aspects of the invention, a device is configured and operable for measuring an electric current as a function of a potential difference between a working electrode and a reference electrode.

In some embodiments of aspects of the invention, the at least one enzyme and at least one redox mediator are confined to a molecular film of the matrix material.

In some embodiments of aspects of the invention, the carbon allotrope having a surface area between 120 and 1315 m²/gr.

In some embodiments of aspects of the invention, the carbon allotrope is selected from carbon nanotubes, graphite, carbon paste, fullerenes, carbon nanobuds, amorphous carbon, glassy carbon, lonsdaleite and carbon nanofoam.

In some embodiments of aspects of the invention, when the electrode is carbon-based, the carbon allotrope is of a different carbonaceous material.

In some embodiments of aspects of the invention, the electrode is a glassy carbon electrode (GCE) and the carbon allotrope is carbon nanotube.

In some embodiments of aspects of the invention, the carbon allotrope is a carbon nanotube (CNT).

In some embodiments of aspects of the invention, the CNT is selected from single walled CNT (SWCNT) and multiwalled CNTs (MWCNT).

In some embodiments of aspects of the invention, the CNT is MWCNT.

In some embodiments of aspects of the invention, the carbon allotrope is selected from a carbon paste, carbon fibers, carbon dots and graphene.

In some embodiments of aspects of the invention, the carbon allotrope is a carbon paste.

In some embodiments of aspects of the invention, the matrix material is a polymeric material or a polyscharide.

In some embodiments of aspects of the invention, the matrix material is selected from polydopamine, agarose, Nafion, chitosan, polyethyelenimine (PEI) and polyvinylpyridine (PVPy).

In some embodiments of aspects of the invention, the matrix material is polydopamine or agarose.

In some embodiments of aspects of the invention, the matrix material is polydopamine.

In some embodiments of aspects of the invention, the matrix material is agarose.

In some embodiments of aspects of the invention, the device being an oxygen-passive biosensor device comprising a surface region of a carbon allotrope and polydopamine as a matrix material layer, associated with said surface region, the polydopamine matrix material layer entrapping at least one enzyme and at least one redox charge mediator.

In some embodiments of aspects of the invention, the device being an oxygen-passive biosensor comprising a surface region of a carbon allotrope and agarose as a matrix material layer, associated with said surface region, the agarose matrix material layer entrapping at least one enzyme and at least one redox charge mediator.

In some embodiments of aspects of the invention, the matrix material is polydopamine fabricated by reacting a polydopamine precursor in presence of the at least one enzyme and the at least one redox charge mediator.

In some embodiments of aspects of the invention, the at least one redox charge mediator is chemically associated to the carbon allotrope.

In some embodiments of aspects of the invention, the at least one redox charge mediator is selected to regain the enzyme original charge following interaction with an analyte.

In some embodiments of aspects of the invention, the at least one redox charge mediator has a redox potential more positive than the redox potential of the at least one enzyme.

In some embodiments of aspects of the invention, the at least one redox charge mediator is selected from substituted naphthoquinones.

In some embodiments of aspects of the invention, the naphthoquinones are substituted by one or more functionalities selected from halids, sulfonate group(s), methyl group(s), methoxy group(s), ester group(s) and aldehyde group(s).

In some embodiments of aspects of the invention, the at least one redox charge mediator is selected from benzyl viologen, indigo disulfonate, methylene blue, 2,5-dihydroxybenzoquinone, ferrocenecarboxaldehyde, ferrocenmethanol, dichloronaphtoquinone (DCNQ) and dichlorophenol indo-phenol (DCPIP).

In some embodiments of aspects of the invention, the redox charge mediator is dichloronaphtoquinone (DCNQ) or dichlorophenol indo-phenol (DCPIP).

In some embodiments of aspects of the invention, the at least one enzyme is anaylte-specific.

In some embodiments of aspects of the invention, the at least one enzyme is selected from glucose dehydrogenase (GDH), lactate dehydrogenase (LDH), lactose dehydrogenase, alcohol dehydrogenase, fructose dehydrogenase and glucose-6-phosphate dehydrogenase.

In some embodiments of aspects of the invention, a glucose sensor.

In some embodiments of aspects of the invention, the at least one enzyme is glucose dehydrogenase (GDH).

In some embodiments of aspects of the invention, the GDH enzyme is a nicotinamide-dependent GDH, a pyrroloquinoline quinone (PQQ-GDH) or a flavin adenine dinucleotide (FAD-dependent GDH, FAD-GDH) enzyme.

In some embodiments of aspects of the invention, the at least one enzyme is FAD-GDH.

In some embodiments of aspects of the invention, a lactate sensor.

In some embodiments of aspects of the invention, the at least one enzyme is lactate dehydrogenase (LDH).

In some embodiments of aspects of the invention, the LDH is a flavin mononucleotide (FMN)-dependent L-LDH.

In some embodiments of aspects of the invention, fabricated as wearable biosensor for in situ, real-time, and non-invasive monitoring of health conditions.

In some embodiments of aspects of the invention, the wearable device is wrist-worn device, a watch, a textile embedded device, a strap-mounted device, a sticker, a patch, or a temporary tattoo.

In some embodiments of aspects of the invention, for determining presence and amount of an analyte in a sample, the analyte being selected from glucose, lactate, ammonia and ethanol.

A glucometer device for detecting presence and/or amount of glucose in a sample, the device comprising an electrode having a surface region comprising or consisting at least one carbon allotrope, the surface region being associated with a polydopamine entrapping FAD-GDH and at least one redox charge mediator.

In some embodiments of aspects of the invention, the at least one redox charge mediator is dichloronaphtoquinone (DCNQ) or dichlorophenol indo-phenol (DCPIP).

In some embodiments of aspects of the invention, implementing FED-GDH and DCNQ.

In some embodiments of aspects of the invention, implementing FAD-GDH and DCPIP.

In some embodiments of aspects of the invention, the sample is an aqueous sample.

In some embodiments of aspects of the invention, the sample is a blood sample, a sweat sample, intestatial fluid sample or a saliva sample.

A biosensor device for detecting presence and/or amount of lactate in a sample, the device comprising an electrode having a surface region comprising or consisting at least one carbon allotrope, the surface region being associated with a polydopamine or agarose entrapping lactate dehydrogenase (LDH) and at least one redox charge mediator.

In some embodiments of aspects of the invention, the at least one redox charge mediator is thionine.

A multi-sensing device for determining presence of two or more analytes, the device comprising one or more biosensor according to the invention.

In some embodiments of aspects of the invention, the device comparing one or more electrodes or electrode regions, each of said one or more electrodes or electrode regions comprising or consisting at least one carbon allotrope associated with a polydopamine entrapping two or more enzymes and at least one redox charge mediator, wherein each of the two or more enzymes being analyte-specific.

In some embodiments of aspects of the invention, the at least one of said two or more enzymes is GDH enzyme, being optionally selected from a nicotinamide-dependent GDH, a pyrroloquinoline quinone (PQQ-GDH) and a flavin adenine dinucleotide (FAD-dependent GDH, FAD-GDH) enzyme.

In some embodiments of aspects of the invention, the at least one of said two or more enzymes is FAD-GDH.

In some embodiments of aspects of the invention, the at least one of said two or more enzymes is lactate dehydrogenase (LDH).

In some embodiments of aspects of the invention, the LDH is a flavin mononucleotide (FMN)-dependent L-LDH.

In some embodiments of aspects of the invention, at least one of said two or more enzymes is GDH enzyme, and at least another of said two or more enzymes LDH.

In some embodiments of aspects of the invention, for measuring glucose to lactate ratio.

A sensing unit comprising:
an electrode assembly comprising at least one working electrode and at least one reference electrode, the at least one working electrode having an active surface of at least one carbon allotrope and a film of polydopamine disposed thereon, the film of polydopamine comprising, entrapping or holding one or more enzymes and one or more redox charge mediators,
a measuring circuit for measuring a change in the current generated by the working electrode at constant potential, as a function of time, and
a connection means to connect said electrodes to the measuring circuit,
the device being configured and operable for functioning when in contact with a medium to be analyzed.

In some embodiments of aspects of the invention, the medium to be analyzed is a physiological medium selected from blood, sweat, intestatial fluid and saliva.

In some embodiments of aspects of the invention, fabricated as wearable biosensor for in situ, real-time, and non-invasive monitoring of health conditions.

In some embodiments of aspects of the invention, the wearable device is wrist-worn device, a watch, a textile embedded device, a strap-mounted device, a sticker, a patch, or a temporary tattoo.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 provides a schematic representation of the FAD-GDH biosensor configuration consisting of MWCNTs, DCPIP, FAD-GDH, and polydopamine layer.

FIGS. 2A-B depict optimization of (FIG. 2A) [GDH] and (FIG. 2A) [DCPIP] in the WE mix respectively. CVs were performed (from −0.3 to 0.2V, 5 mV/sec), and the peak current for a given [GDH] or [DCPIP] was recorded for (FIG. 2A) or (FIG. 2B) respectively.

FIG. 3 provides the CV of the biosensor with or without 40 mM glucose (5 mV/s sweep speed, pH=7.4, from −0.3V to 0.2V). A mix of GCE-MWCNT-PDA-DCPIP with (solid, dot) or without (dashed, dot dashed) FADGDH in the absence or presence of 40 mM glucose respectively. Inset—saturation curve of WE response to increasing concentrations of glucose.

FIG. 4 is a CV of a DCNQ-based biosensor before (solid) and after (dashed) addition of 40 mM glucose (5 mV/sec sweep speed, pH=7.4, from −0.3V to 0.2V). Inset—saturation curve of WE response to increasing concentrations of glucose.

FIG. 5 is a live amperometric response to interferents. DCNQ-based biosensor was subjected to CA (0V applied voltage, pH=7.4). Chemicals were introduced into the solution marked by the arrows: U—68 μg/ml uric acid, g—2.5 mM glucose, Asc—0.1 mM ascorbic acid, Aca—1.1 mM acetoaminophen and 2 g-5 mM glucose. Interferents were added in sequence from left to right respectively after current stabilization. The measurement was briefly paused and continued after each interferent addition allowing homogenization via pipetting.

FIG. 6 shows an averaged normalized current versus rising glucose concentration obtained from three repeats of the experiment described herein. The data points were normalized according to the current at 10 mM, before the addition of ascorbic acid.

FIG. 7 shows electrode stability over three days at 0V vs. Ag/AgCl, 10 mM glucose, pH=7.4. The optimized biosensor was measured until current stabilization (˜2 min), after which glucose was added. The measurement was briefly paused to mix the solution and then continued for three days. Near the end of the measurement, 10 mM glucose was added to re-examine the amperometric response, which is shown in the inset.

FIG. 8 is a CV of an optimal DCPIP-based biosensor before (solid) and after (dashed) addition of 40 mM glucose under argon atmosphere (5 mV/sec sweep speed, pH=7.4, from −0.3V to 0.2V).

FIGS. 9A-B show results of a mediator entrapment assay, where (FIG. 9A) DCPIP and (FIG. 9B) DCNQ based biosensors were scanned via CV (from −0.3V to 0.2V, 5 mV/s, vs. Ag/AgCl) at different scan rates. Peak anodic current was plotted against the scan rate to examine the fixation of mediator in the matrix.

FIG. 10 is a CV of an AQS-based biosensor before (solid) and after (dashed) addition of 40 mM glucose (from −0.3V to 0.2V, 5 mV/s, vs. Ag/AgCl). The inset describes the redox profile of diffusional 25 μM AQS in 0.1M KPi pH=7.4.

FIG. 11 is a CV of a dopamine-based biosensor without any redox mediators. The biosensor's response before (double dot dashed) and after (dashed) 40 mM glucose addition was examined via CV (from −0.3V to 0.2V, 5 mV/s, vs. Ag/AgCl). The biosensor was prepared as described above while skipping DCNQ deposition and not adding any DCPIP into the deposited mix.

FIGS. 12A-B are SEM images of (FIG. 12A) ITO-MWCNTs and (FIG. 12B) ITO-MWCNTs-pDopa-DCPIP-GDH. MWCNTs and biosensor mix were deposited on ITO as they were deposited on the GCE.

FIGS. 13A-B show DCNQ-based biosensor optimization. Six GC-MWCNTs-DCNQ electrodes were coated each with a different mix containing rising concentrations of GDH.

FIG. 14 shows an amperometric response of DCNQ-based biosensor. The amperometric response of 3 individual electrodes was plotted vs. glucose concentration based on replication of the experiment herein. The experiment was performed separately for each electrode.

FIGS. 15A-D show CVs and saturation curves of (FIG. 15A) Au and (FIG. 15B) Toray paper electrodes. The electrodes were scanned before (solid) and after (dashed) addition of 40 mM glucose (5 mV/sec sweep speed, pH=7.4, from −0.3V to 0.2V). (FIG. 15C and D)—saturation curve of each electrodes' response to increasing concentrations of glucose at 0V and −0.1V respectively.

FIG. 16 shows the colony PCR: PCR was used to verify correct transformation into BL21(DE3). The rightmost colony was chosen (#13), since it shows a positive band at the right bp length (˜500).

FIG. 17 depicts elution of ScLDH from the Hiprep DEAE FF 16/10 column using the AKTA go system. The protein starts eluting at 190 ml, 20% B buffer.

FIG. 18 provides the absorbance spectrum of the concentrated, purified ScLDH diluted 50 times in 0.1M KPi pH=7.5.

FIG. 19 provides a scheme for biosensor fabrication—the top row describes the thionine-based sensor, the middle row describes the DCPIP based sensor, and the bottom row describes a DET-capable biosensor.

FIG. 20 shows CVs of the thionine-based L-lactate biosensor before (solid) and after (dashed) addition of 18 mM DL-lactate. The measurement was performed in 0.1M KPi pH=7.5 using a scan rate of 5 mV/s.

FIG. 21 depicts the change in current in response to rising levels of L-lactate. The data was taken from individual CVs of the thionine-based biosensor using the current measured at 0V vs. Ag/AgCl. The measurement was repeated three times.

FIG. 22 shows CVs of the DCPIP-based L-lactate biosensor before (solid) and after (dashed) addition of 18 mM DL-lactate. The measurement was performed in 0.1M KPi pH=7.5 using a scan rate of 5 mV/s.

FIG. 23 depicts the change in current in response to rising levels of L-lactate. The current measured at 0V vs. Ag/AgCl was taken from individual CVs of the DCPIP-based biosensor and plotted vs. [L-lactate].

FIG. 24 depicts the DET capabilities of ScLDH deposited on GCE-MWCNT. CV was used to characterize the capabilities of MWCNT with (dot, dashed dot) or without enzyme (solid, dashed) before and after the addition of 8 mM DL-lactate respectively.

FIG. 25 depicts L-lactate chronoamperometry under the effects of interferents. The following analytes were added in sequence from left to right: 2 mM L-lactate repeated twice (lac), ascorbic acid (asc), uric acid (ua), acetoaminophen (aca), 50 mM glucose (glu), 2 mM L-lactate repeated twice (lac).

FIG. 26 shows the effects of interferents on lactate sensing. The current at varying L-lactate concentrations taken at 0V vs. Ag/AgCl from three separate experiments (depicted in FIG. 25) was plotted.

FIG. 27 shows the bioelectrocatalytic current generated using the FMN-LDH a subunit (catalytic domain of ScLDH) in the thionine configuration. The biosensor was characterized via CV before (solid) and after addition of 5, 10 and 15 mM L-lactate (dashed, dot and dot-dashed respectively).

FIG. 28 provides a schematic representation of a lactate biosensor configuration.

### DETAILED DESCRIPTION OF EMBODIMENTS

The invention disclosed herein generally concerns a new strategy for the development of a stable amperometric glucose biosensor based on FAD-GDH. While specific examples are provided that utilize polydopamine and agarose as matrix materials, and while glucose and lactate sensors are exemplified, the technology may be extended and be similarly applied to the construction of other sensors, meeting principals disclosed and discussed herein.

The developed biosensor exhibits high accuracy, high bioelectrocatalytic currents, good linear response, low overpotentials and great stability. Furthermore, the developed method can be used for the construction of an amperometric glucose sensing device on a variety of electrode surfaces.

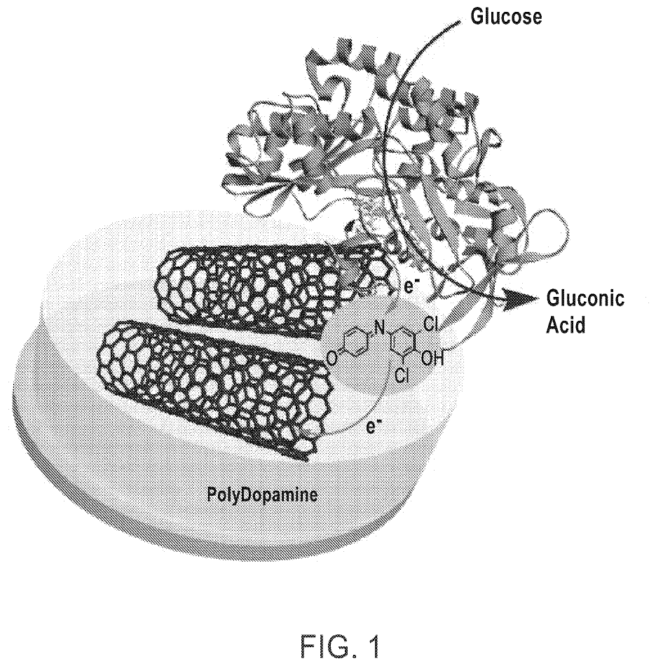

To construct the biosensor, the FAD-GDH enzyme was co-entrapped in a polydopamine layer with DCPIP or 2,3-dichloro-naphthoquinone (DCNQ) as redox mediators. The developed sensors were characterized and examined in terms of stability, interferences effect and maximal bioelectrocatalytic currents. For the biosensors assembly, the glassy carbon electrode (GCE) was first modified with 5 ul MWCNTs (5 mg/ml in dimethylformamide). The dried electrode was further modified with a mixture containing dopamine, DCPIP and FAD GDH enzyme dissolved in pH 8.5 Tris Buffer. The electrodes were allowed to polymerize to form a polydopamine layer consisting of the DCPIP mediator and the FAD-GDH enzyme. FIG. 1 schematically presents the biosensor assembly method. While the assembled bioanode has shown good bioelectrocatalytic currents in the presence of glucose, the ratio between the components was further studied in order to achieve maximal bioelectrocatalytic currents.

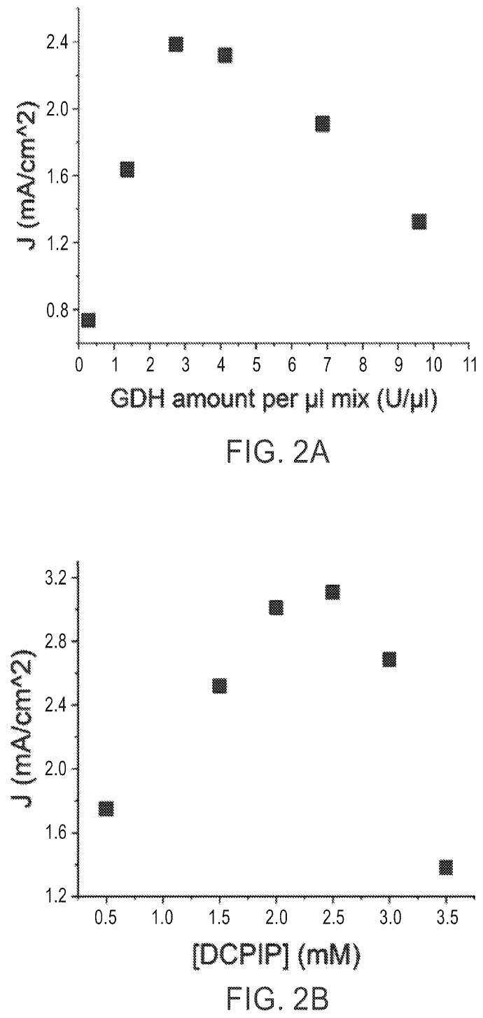

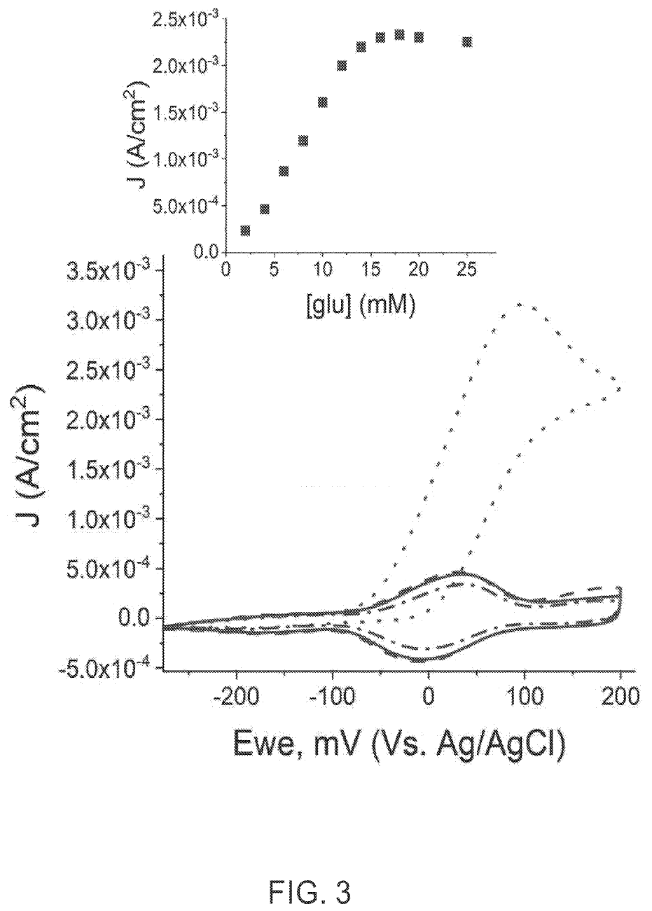

First, the DCPIP and the FAD GDH loading amounts were varied on the tested MWCNTs/GCE electrodes, as seen in FIG. 2. The best bioelectrocatalytic currents were reached while 3 U/ul of FAD-GDH were added (FIG. 2A). The addition of higher amounts forced a decline in the bioelectrocatalytic currents. This might be a result of the high amount of insulating proteins that disrupt efficient electrical communication with the MWCNTs and the electrode. The GDH optimized amount was then tested with different DCPIP loading. An optimized biosensor displays ˜3 mA/cm² of bioelectrocatalytic currents with 2.5 mM of the mediator loaded during the assembly process (FIG. 2B). The optimization measurements were performed in the presence of 40 mM of glucose in the testing solution and prior to each measurement, the electrode was soaked in 0.1M KPi, pH 7.4 buffer for 5 minutes to remove any unbound FAD-GDH or redox mediators. The DCPIP and FAD-GDH content on the biosensor electrode was further calculated. This was achieved by directly monitoring the redox wave of the redox mediator and by an indirect method used to measure the integrated FAD-GDH, as shown further below. While the loading amounts of the components are known, the actual entrapped amount on the electrode surface of the optimized configuration should be determined. For that, the bonded content of DCPIP was determined by integrating the oxidation wave attributed to the mediator at 0V vs. Ag/AgCl in the absence of glucose (FIG. 3).

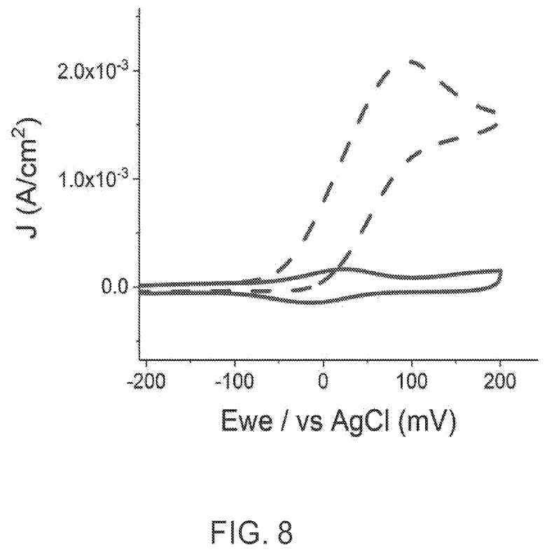

To determine FAD-GDH content, we incubated the electrode in phosphate buffer to determine protein desorption via absorbance at 280 nm. To minimize the false absorbance of other mix components at the UV region, we used a membrane filter to purify the desorbed protein. We estimated the adsorbed enzyme amounts to be 87 pmole while 22 pmole of DCPIP were entrapped in the polymer. Polydopamine is a redox-active polymer with semi reversible redox behavior. Nevertheless, the polydopamine does not act as an electron transfer mediator and does not have any role in the enzyme activation. FIG. 3 shows the bioelectrocatalytic currents obtained using the optimized biosensor. As depicted, the bioelectrocatalytic onset potential is dictated by the redox potential of the DCPIP, which is ˜200 mV more negative than the polydopamine oxidation wave. The maximal bioelectrocatalytic currents levels off at 0.05V vs. Ag/AgCl, reaching above 3 mA/cm². To verify that indeed the developed biosensor is not influenced by the presence of oxygen, the sensor was tested under Ar atmosphere at purged glovebox and a similar bioelectrochemical catalytic current was observed (FIG. 8).

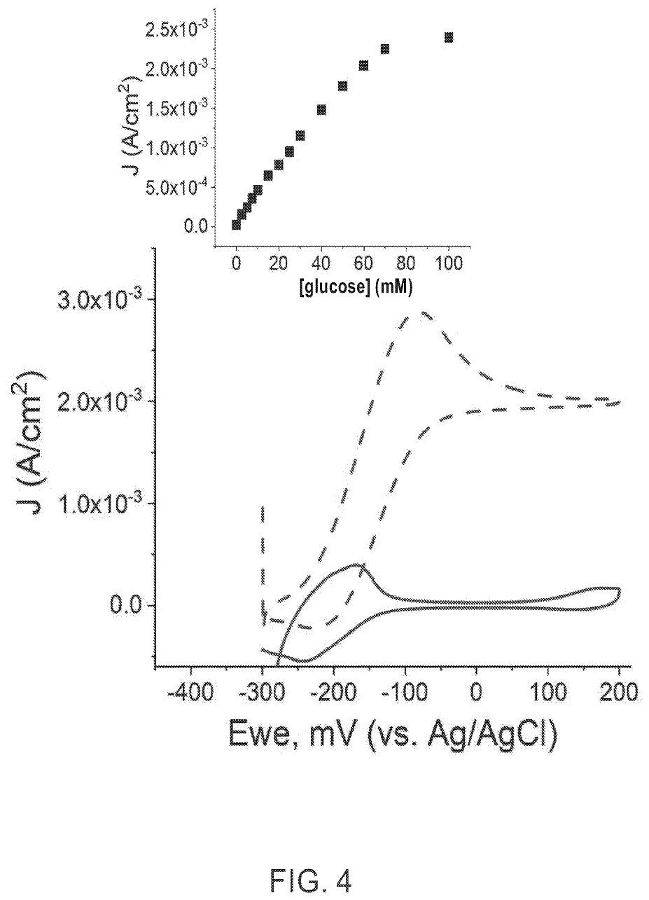

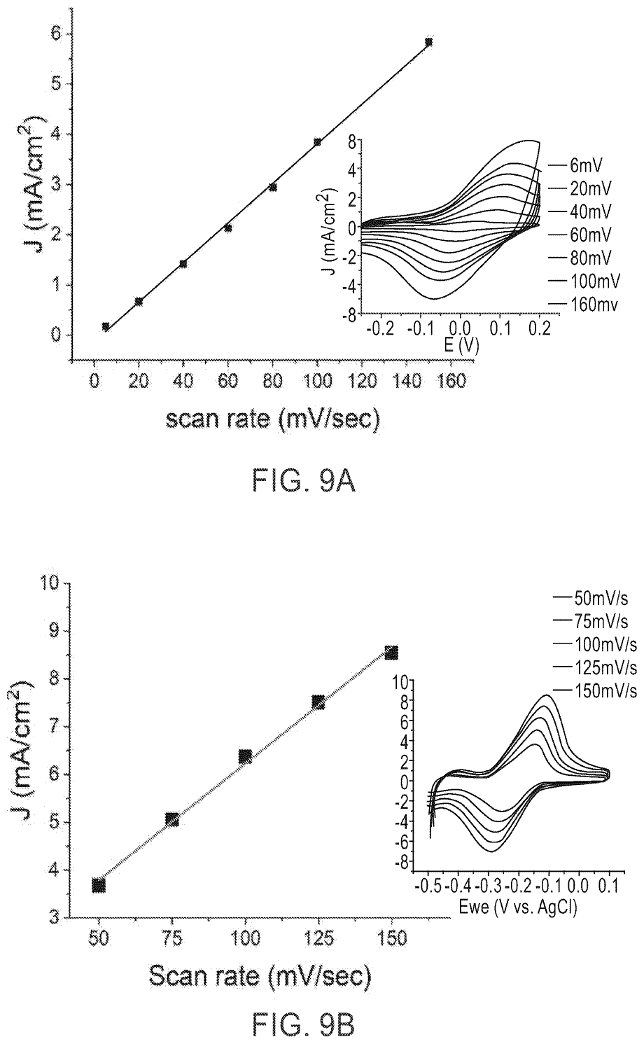

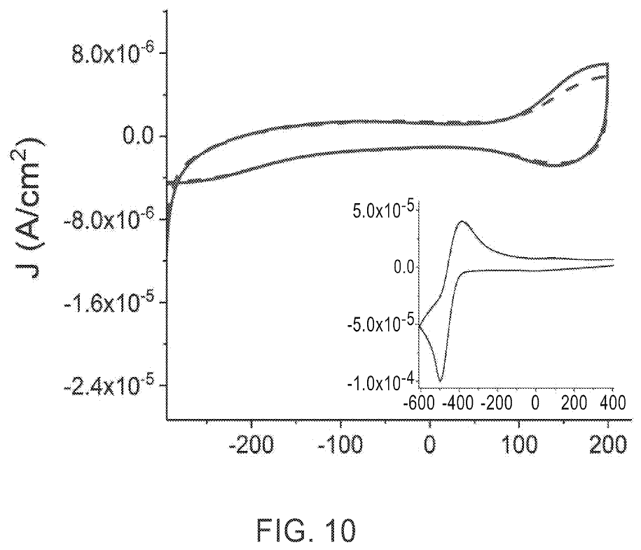

To verify that indeed the DCPIP redox mediator is surface-confined, we used the Laviron method and plotted the peak anodic current vs. scan rate (FIG. 9). A linear correlation can be seen, confirming that indeed the DCPIP molecules are bonded to the electrode surface. The optimized sensors were tested under varying glucose concentrations (FIG. 3 inset). As depicted, linear response at the range of 0-10 mM of glucose concentrations was obtained. By assuming Michaelis Menten's kinetics and by knowing the adsorbed enzyme amounts on the electrode, we estimated the electron transfer rate (k_{ET}) to be 149 s⁻¹. While DCPIP shows great promise as a redox mediator for the FAD-GDH bioelectrocatalytic activation, the maximal bioelectrocatalytic currents are reached at 0.1V vs. Ag/AgCl. At this potential, interferents like uric acid, paracetamol, antibiotics and ascorbic acid may be oxidized directly on the electrode surface. This may lead to false readings and also limit the biosensor's accuracy. Using lower activation potential should minimize these undesired reactions, and improve the sensor capabilities. FAD-GDH a subunit variants consist of a FAD cofactor at the active site, and in several variants, a Fe—S cluster which acts as an internal redox-active mediator. While the FAD cofactor is buried in the protein shell, the Fe—S cluster is more exposed and accessible to the solution or to external redox mediator. The redox potential of the two redox centers, the FAD and the Fe₃S₄ are at −0.48V and −0.2V vs. Ag/AgCl respectively. In our experiments, FAD-GDH originates from Asp. Sp. was used (Sekisui Diagnostics), which was expected to not have a Fe₃S₄ cluster. To confirm that, ICP-OES measurements were performed, and indeed, Fe was absent in the samples (results not shown). Ideally, the redox potential of the mediator should be as close as possible to the redox potential of the enzyme active site to allow minimal overpotential. For that, we examined two additional redox-active mediators consisting of a redox potential of −0.45V and −0.2V, (i) sulfonic antracenequinone (AQS) and (ii) dichloronaphthoquinone (DCNQ), respectively. While AQS did not show any bioelectrocatalytic activity (FIG. 10), DCNQ exhibited high bioelectrocatalytic response while coupled to the FAD-GDH enzyme as depicted in FIG. 4. This result is with agreement with previously work with naphthoquinones as redox mediator. In Contrary to the high solubility of DCPIP in aqueous solution, DCNQ as limited one, therefore, additional deposition step was used for the biosensor construction. The GCE/MWCNTs electrode was first modified with the DCNQ solution (10 mM in DMF), followed by the addition of the FAD-GDH/dopamine solution. As depicted in FIG. 4, the onset potential of the bioelectrocatalytic currents shifted to −0.2V vs. Ag/AgCl which is approximately 200 mV more negative compared to the original DCPIP based configuration.

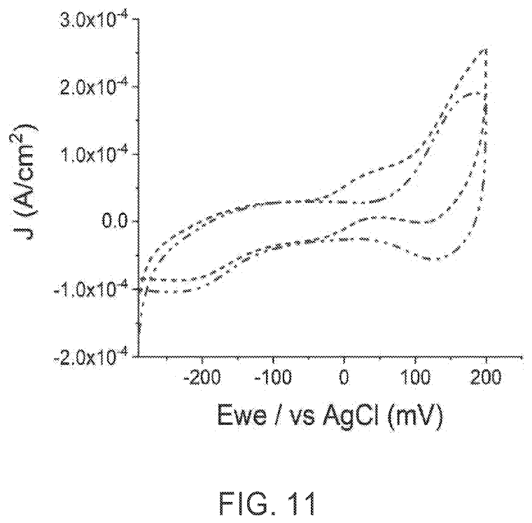

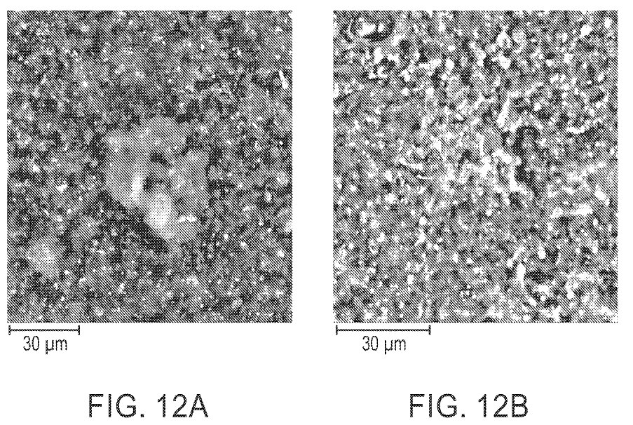

By analyzing the obtained cyclic voltammogram in the absence of glucose (FIG. 4, red curve), two redox waves could be seen at −0.2V and at 0.15V. The later redox species can be correlated to the polymerized layer of polydopamine. Despite the reversible redox wave which could thermodynamically fit the enzyme's requirement for bioelectrocatalytic activation, the polydopamine layers do not contribute to the total current gained. By excluding DCNQ, negligible bioelectrocatalytic currents could be measured (FIG. 11). Although the polydopamine layer does not contribute to the electron transfer process, it can create strong hydrophobic interactions with the enzyme and the redox mediator, which add structural support to the developed sensor. It has been shown that amines or thiols can form covalent interactions with the polydopamine surface, thus allowing the covalent attachment of the proteins. Those properties allow good integration of the biosensor content to the electrode, while still allowing hydrophilic molecules like glucose and gluconic acid to diffuse in and out of the very porous matrix. This was confirmed by SEM images of the biosensor surface. (FIG. 12).

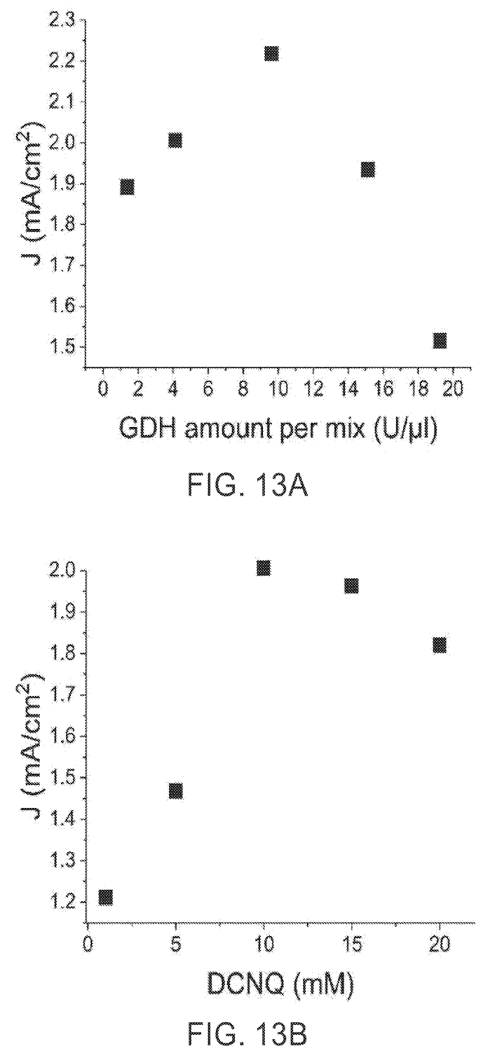

The DCNQ based biosensor was further optimized in terms of the redox mediator and enzyme content in the polymeric layer (FIG. 13). The optimized biosensor's amperometric response was further examined under increasing amounts of glucose (FIG. 4 inset). A linear amperometric response can be seen between 0-20 mM of glucose under an applied potential of 0V vs. Ag/AgCl. These ranges fully support the desired range for diabetic patients' treatment. The bioelectrocatalytic currents levels off at ˜100 mM with bioelectrocatalytic currents reaching 2.3 mA/cm² at 0V vs. Ag/AgCl. Knowing the FAD-GDH content and the maximal bioelectrocatalytic currents, the kET rate was calculated to be 148 s⁻¹.

High bioelectrocatalytic currents at low redox potentials with linear response to the analyte are an essential requirement for amperometric biosensors. Nevertheless, long term stability and low effect of interferents are crucial for real-time continuous glucose monitoring devices.

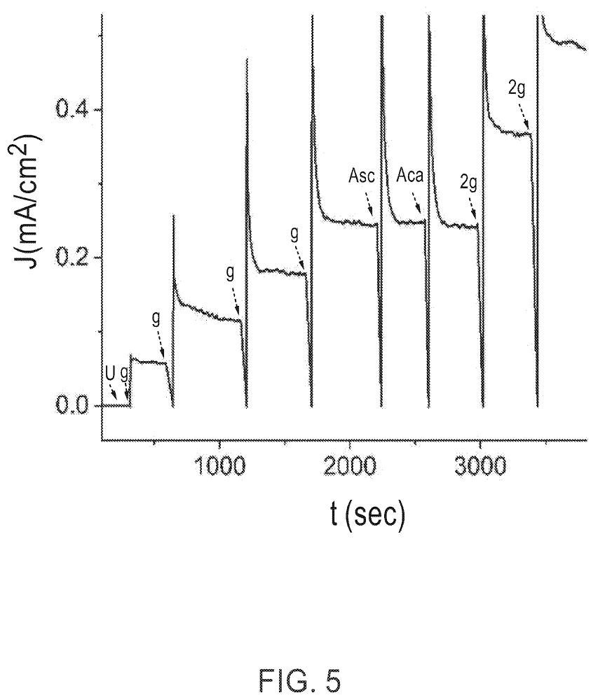

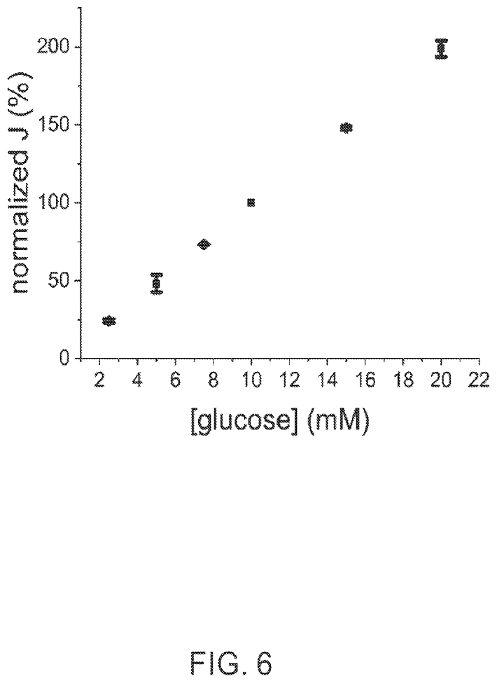

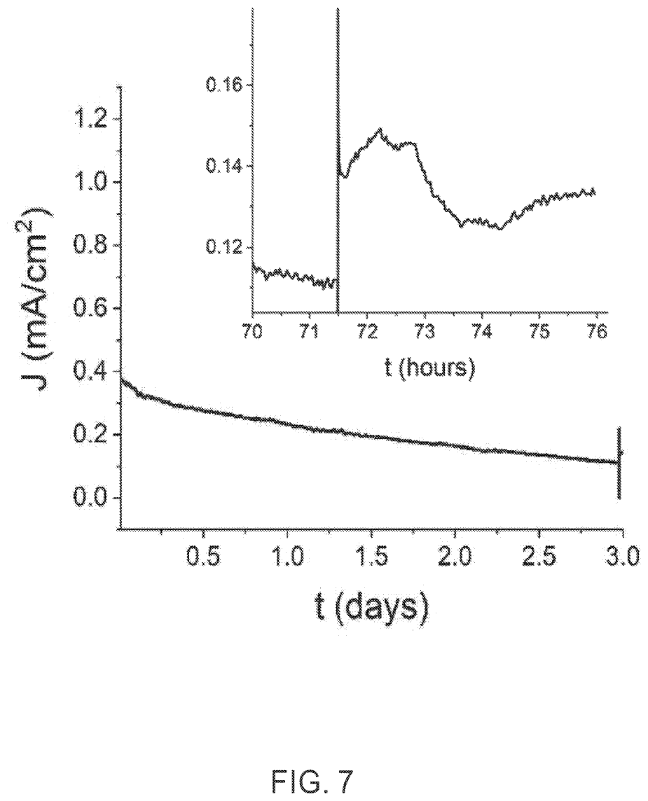

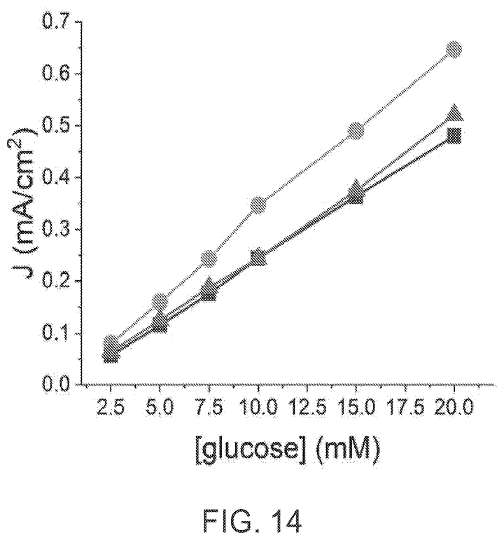

Therefore, we tested the electrode chronoamperometry (CA) under an applied potential of 0V. Common interferents with glucose monitoring devices were added, and low or no effect of the common interferents on electrode activity was observed (FIG. 5). As depicted, an addition of 2.5 mM or 5 mM glucose led to current “jumps” while uric acid, ascorbic acid or paracetamol did not show any increase in the bioelectrocatalytic currents. By plotting the amperometric response against the added glucose concentration, a linear trend was observed, showing small deviations between the fabricated electrodes (FIG. 6 and FIG. 14). The statistical analysis of the activity of the electrode has shown high accuracy and reproducibility which is promising for future development. We attribute the small differences to the MWCNT deposition technique, which sometimes does not cover the entire conductive surface of the electrode evenly. With these encouraging results, we further measured the electrode stability extended period of three days (FIG. 7).

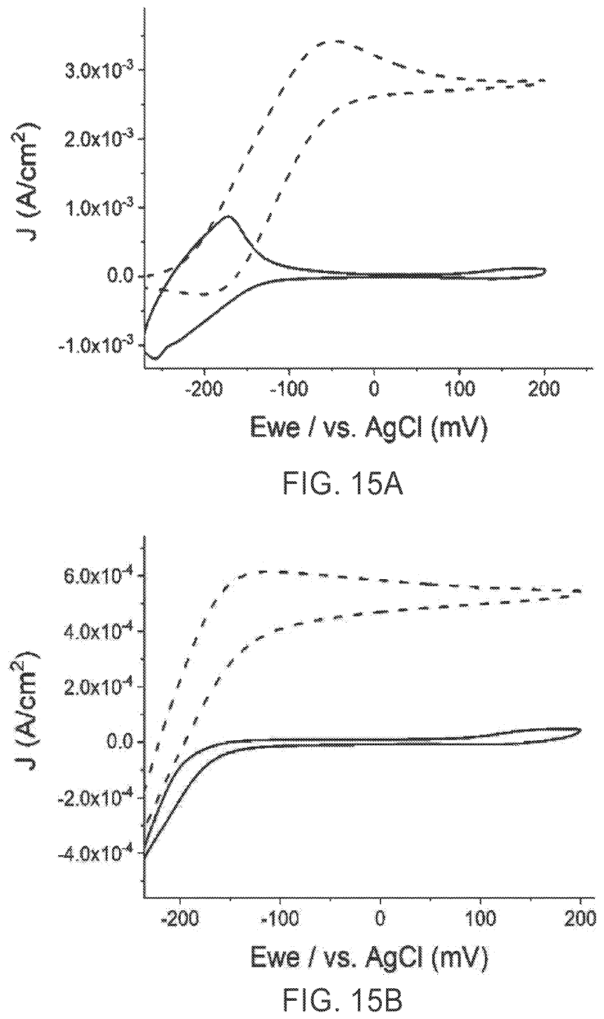

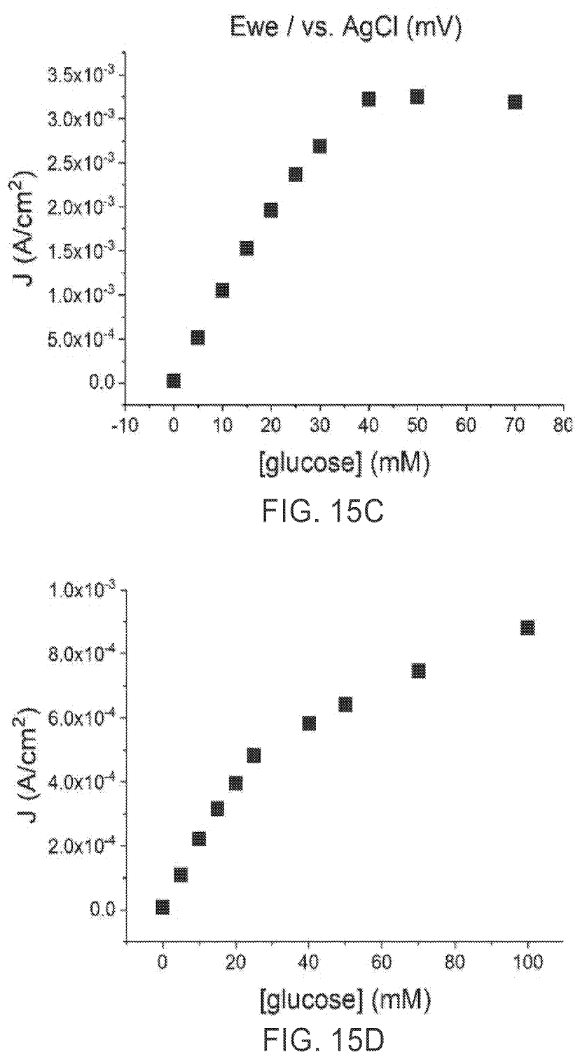

As depicted, under an applied potential of 0V (vs. Ag/AgCl) the biosensor remained active for at least 3 days as confirmed by the second addition of glucose to the tested solution (FIG. 7 inset). Those results strongly support the feasibility of the developed system to become suitable for an applied continuous glucose monitoring device. The biosensor can also be applied to other types of electrodes, including cheap scalable ones like Toray paper (FIG. 15). Additional measurements under in vivo conditions should be further performed to examine if an additional polymeric layer is required to prevent passivation of the sensor surface by blood proteins.

In conclusion, we presented a new methodology to entrap enzymes and redox mediators for the construction of glucose amperometric biosensors. We presented two configurations based on FAD-GDH, polydopamine and DCPIP or DCNQ. Both sensors exhibited high bioelectrocatalytic currents reaching above 2 mA/cm², with linear response capped at 10 or 20 mM with a high turn over rate of 149 s⁻¹ and 148 s⁻¹ for DCPIP or DCNQ respectively. The DCNQ based biosensor can be activated at low applied potentials with minimal response to interferents. The polydopamine entrapment method of the redox mediators and the FAD-GDH enzyme have shown great stability for at least three days of activation at 0V in a 10 mM glucose solution. The promising methodology could pave the way for further development of commercial continuous glucose monitoring devices and might be further utilized with other enzymes to sense other desired biomarkers in point of care applications.

### Reagents and Instrumentation

Glassy carbon electrodes (GCE, 3 mm diameter) were purchased from CH-Instruments. Dichlorophenolindophenol (DCPIP), dopamine, Uric acid and Glucose were purchased from Sigma-Aldrich. Dimethylformamide was purchased from Bio-lab. Ascorbic acid was purchased from Fisher Scientific. Multi wall carbon nanotubes (MWCNTs) were purchased from Nanointegris (MWCNTs, 99 wt %, <20 nm OD). FAD dependent Glucose Dehydrogenase (FAD-GDH, 1150 U/mg) was purchased from Sekisui Chemicals. 2,3-dichloro-naphthoquinone (DCNQ) 98% was purchased from Acros Organics. Acetoaminophen was obtained via crushing a 500 mg commercial paracetamol tablet (Teva pharmaceuticals, Israel). All chemicals and reagents were used without further purification. One and 0.05 micron alumina beads were purchased from BAS (Japan) and CH-instruments (USA) respectively.

All graphs were prepared with Origin software (Originlab, USA). All electrochemical measurements were performed using the Biologic SP-200 potentiostat, supported by EC-lab software (BioLogic, France).

DCPIP Working Electrode (WE) Optimization Assay

All GCEs (0.07 cm² surface area) were polished with 1 μm and 0.05 μm alumina beads in sequence. MWCNTs solution (5 mg/ml) was prepared by dissolving MWCNTs in Dimethylformamide (DMF) followed by sonication for 30 minutes at RT. Then, five ill of the MWCNTs solution were deposited on each GCE, which were then dried in vacuo at RT for 30 minutes. For GDH concentration optimization, a mixture of DDW, TRIS/HCl pH=8.5, dopamine, DCPIP and FAD-GDH was prepared. The concentrations of TRIS, dopamine and DCPIP were set (50 mM, 0.3 mg/ml and 10 mM, respectively), while GDH concentration was changed from 1.25 mg/ml to 8.75 mg/ml. Five microliters of the mixture were deposited on each GCE, which were then incubated for one hour at RT. Then, each GCE was incubated in 25 ml of 0.1 M KPi pH=7.4 for five minutes in order to remove any unbounded enzyme or mediators. Cyclic voltammetry (CV) measurements were then performed using a scan rate of 5 mV/sec, scanning from −0.3 V to 0.2 V vs. Ag/AgCl. Scans were performed with or without the presence of 40 mM glucose (measurement solution was changed between electrodes). For DCPIP concentration optimization, the mixture was prepared again in the same fashion, only with GDH concentration set to 3.75 mg/ml and DCPIP concentration was changed from 0.5 to 3.5 mM. Five microliters of the mixture were deposited on each MWCNT-modified GCE, which were then incubated for one hour at RT. Each WE was incubated in 25 ml of 0.1 M KPi pH=7.4 for five minutes, then measured via CV as mentioned above with or without the presence of 40 mM glucose (measurement solution for each WE was changed between measurements). The Current at 0.2 V vs. Ag/AgCl was plotted vs. glucose concentration.

Optimal DCPIP-Based Biosensor Preparation

Five μl of the MWCNTs solution were deposited on each GCE, which were then dried in vacuo at RT for 30 minutes. Then, DDW, TRIS/HCl pH=8.5, dopamine, DCPIP and GDH were mixed (final concentrations of 50 mM, 0.3 mg/ml, 2.5 mM and 4 U/μl respectively) and deposited on the MWCNTs modified GCE, as described above. The electrode was then incubated for 1 h at RT.

Optimal DCPIP-Based Biosensor Measurement without Oxygen

An optimal DCPIP electrode was prepared as was mentioned described above, and its response to 40 mM glucose was measured under Ar atmosphere via CV. The WE was incubated in 25 ml of 0.1 M KPi pH=7.4 for five minutes, then measured (scan rate of 5 mV/sec, scanning from −0.3V to 0.2V vs. Ag/AgCl).

Saturation Curve

An optimized WE was prepared according to the optimization assay results and measured via CV as mentioned above. Initial glucose concentration was set to two mM, and the CV measurement of the optimized WE was performed one minute after glucose addition. This was repeated with stepwise additions of 2 mM glucose up to 20 mM, as well as 25 mM. The current at 0.2V vs. Ag/AgCl was plotted against glucose concentration.

Quantification of Redox Mediator Deposited on the Electrode

The amount of DCPIP and DCNQ adsorbed on the electrode (in moles) was quantified according to the following equation:

n_{mediator=Q/Z·F} (1)

where Q is the overall charge involved in the oxidation, z is the number of electrons involved in each reaction (2 in our case) and F is the Faraday constant. Q was derived from the integrated current involved in the oxidation of the mediator, which can be detected via CV. The total charge was calculated as such:

$${n}_{DCPIP} = \frac{Q}{z \cdot F} \qquad ( 2 )$$

$$dQ = I \cdot dt \qquad ( 3 )$$

$$v = V / t \qquad ( 4 )$$

$$Q = \int dI \cdot t = \int \frac{dI \cdot dV}{v} \qquad ( 5 )$$

where ν is the scan rate. For DCNQ, the measurements were performed under Ar to avoid O₂ interference, while using the same equations for calculation.

Mediator Entrapment Assay

The optimal electrode was scanned at different scan rates via CV (from −0.3V to 0.2V vs. Ag/AgCl). The peak anodic currents were plotted against their appropriate scan rates in Origin.

Quantification of Adsorbed GDH on the Electrode Surface

The electrode was incubated in 200 μl of KPi 0.1 M pH=7.4 for 50 minutes at RT. The electrode was carefully removed, and 100 μl of the KPi solution were transferred to a 10 kDa Nanosep, which was then centrifuged (4,000 RPM, 10 minutes, 4° C.). DDW were added to the filtrate and the filtrant up to 180 μl. Both of which were measured via spectrophotometry. The desorbed protein concentration was deduced from the absorbance at 280 nm of the filtrant (ε₂₈₀=136 mM⁻¹ cm⁻¹). The amount of protein desorbed after 50 minutes was subtracted from the total amount in the deposited mix to yield the electrode bound enzyme concentration:

n_{GDH adsorbed}=nₘᵢₓ−n_{desorbed} (6)

nₘᵢₓ=[GDH]_{stock}·V_{deposit}·V_{GDH}/Vₘᵢₓ (7)

n_{GDH desorbed}=(Abs₂₈₀)/(ε₂₈₀·l·V_{quant}) (8)

Where nₘᵢₓ is the amount of GDH moles deposited on the electrode surface, [GDH]ᵢₙᵢₜ is the stock concentration of GDH, V_{deposit} is the mix volume deposited on the GCE, V_{GDH} is the volume of stock solution added to the mix, Vₘᵢₓ is the total mix volume, 1 is the path length (1 cm) and V_{quant} is the volume of the solution examined via spectrophotometry (200 μl).

k_{ET} Calculations

The electron transfer rate constant was calculated according to the protein desorption results and the following equation:

k_{ET}=Jₘₐₓ/(z·F·Γ_{GDH}) (9)

Where Jmax is the peak current flux calculated from the saturation curve, z is the amount of transferred electrons in each redox reaction (2), F is the faraday constant and Γ_{GDH} is the area coverage of the enzyme, which is the amount of adsorbed protein calculated above.

SEM Measurements

An optimal biosensor was prepared as mentioned above using ITO as a base instead of a GCE. A strip containing the adsorbed MWCNT-pDopa-DCPIP-GDH was excised with a diamond knife for SEM imaging. The strip was incubated for 1 h in vacuo at RT and measured via scanning electron microscopy (Phenom Pro, Thermo Fischer).

Anthraquinone-Sulfonate (AQS) Biosensor Preparation and Measurement

AQS was dissolved in 25 ml KPi pH=7.4 to a final concentration of 25 μM, after which the solution was measured via CV (−0.6V to −0.2V vs. AgCl, 100 mV/s) to generate the redox profile of the molecule.

The biosensor was prepared according to the optimal conditions mentioned above, with the exception of using AQS instead of DCPIP. AQS was dissolved in 20% DMSO (v/v) to create a stock solution of 10 mM, which were added to the mix as the redox mediator to reach a final concentration of 2.5 mM.

The biosensor response to 40 mM glucose was measured via CV. The WE was incubated in 25 ml of 0.1M KPi pH=7.4 for 5 minutes, then measured (scan rate of 5 mV/sec, scanning from −0.3V to 0.2V vs. Ag/AgCl).

DCNQ-Based Biosensor Optimization

First, MWCNTs were deposited on GCE as described above. Then, 10 μl of 10 mM DCNQ (dissolved in DMF) were deposited on GCE-MWCNTs and dried in vacuo for 30 minutes at RT. A five μl mixture of 0.3 mg/ml dopamine and 1/2/3/4/5 mg/ml GDH in 50 mM TRIS/HCl pH=8.5 were deposited on GCE-MWCNT-DCNQ, which were then dried in the dark at RT. The different electrodes were incubated in 25 ml KPi 0.1M pH=7.5 for 5 minutes, then scanned via CV (from −0.3V to 0.2V, 5 mV/s, vs. Ag/AgCl). The measurement was repeated with the presence of 40 mM glucose in the solution.

For DCNQ optimization, MWCNTs were deposited on GCE as described above. Then, 10 μl of 1/5/7.5/10/25 mM DCNQ (dissolved in DMF) were deposited on GCE-MWCNTs and dried in vacuo for 30 minutes at RT. A five μl mixture of 0.3 mg/ml dopamine and 3.75 mg/ml GDH in 50 mM TRIS/HCl pH=8.5 were deposited on GCE-MWCNT-DCNQ then dried in the dark at RT. A protein concentration of 8.75 mg/ml was also examined (which has shown maximal sensitivity) but displayed very little difference in real-time chronoamperometry (CA) measurements in favor of 3.75 mg/ml FAD-GDH (results not shown). The different electrodes were incubated in 25 ml KPi 0.1M pH=7.5 for 5 minutes, then scanned via CV (from −0.3V to 0.2V, 5 mV/s, vs. Ag/AgCl) before and after addition of 40 mM glucose.

DCNQ-Based Optimal Biosensor Fabrication

MWCNTs were deposited on GCE as was described above. Then, 10 μl of 10 mM DCNQ (dissolved in DMF) were deposited on GCE-MWCNTs and dried in vacuo for 30 minutes at RT. A five μl mixture of 0.3 mg/ml dopamine and 3.75 mg/ml GDH in 50 mM TRIS/HCl pH=8.5 were deposited on a MWCNTs-DCNQ modified GCEs, which were then dried in the dark for 1 h at RT.

DCNQ-Based Biosensor Interference Assay

Three optimal DCNQ-based biosensors (prepared as described above) were subjected to CA (0V applied voltage). Analytes were introduced in sequence into the solution to increase the final concentration by a fixed amount: U—68 μg/ml, g—2.5 mM glucose, Asc—0.1 mM, Aca—1.1 mM and 2 g-5 mM. Analytes were added in sequence (from first to last respectively) after current stabilization, and the measurement was briefly paused to allow homogenization of the solution using a pipette.

The current after stabilization for each electrode was recorded and plotted against glucose concentration. The results were averaged and displayed in FIG. 7, along with the mean error for each data point.

DCNQ-Based Biosensor Stability Measurement

An optimized WE was prepared and measured via chronoamperometry (CA) (0V vs. Ag/AgCl was applied in 20 ml KPi pH=7.4). After current stabilization, 10 mM glucose was added, and the measurement continued for three days. Near the end of the measurement, additional 10 mM glucose was added, and the measurement continued for four more hours.

FMN-LDH Bioanode

In a similar fashion, an L-lactate biosensor was constructed and tested. The components of the sensor were glassy carbon electrode, multi-walled carbon nanotubes and FMN dependent L-LDH from baker's yeast (ScLDH), standalone or combined with either DCPIP or agarose+thionine. Besides the mediated electron transfer (MET) configurations, the system enabled direct electron transfer (DET) process with the electrode.

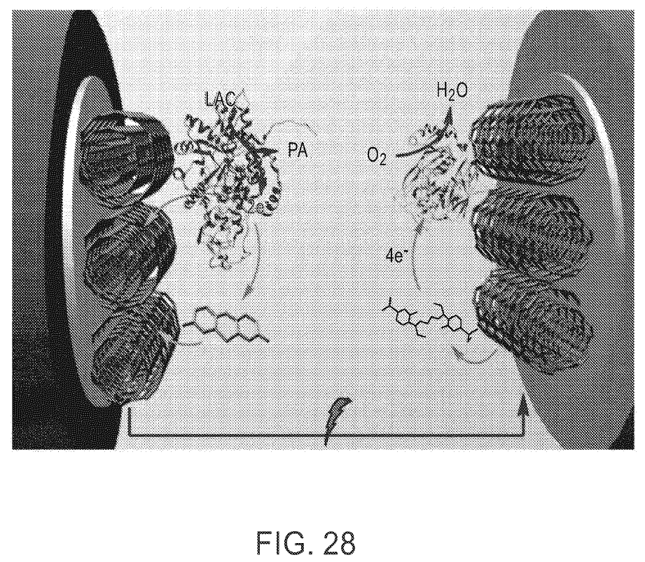

A Lactate Biosensor is Depicted in FIG. 28.

The protein is soluble, and is without glycosylation since it is overexpressed in E. coli and not in yeast. The protein used has 2 domains—heme domain and FMN catalytic domain. Both domains were connected via a short hinge domain.

Overexpression was performed using the T7-IPTG method. Though the protein contains a histag, it was not used for purification. This is due to the imidazole used in histag purification process, which damages the enzymatic activity.

The presented FMN-LDH bioanode technology enables lactate sensing with oxygen insensitivity, high signal to noise ratio with a maximal current reaching ˜500 μA/cm² at potential below 0V vs. Ag/AgCl and a linear current to lactate coloration at the range of 0 to 8 mM. It is also capable of DET, even at low potential. Thus, this biosensor can be used for lactate biosensing, as a bioanode in a lactate oxygen biofuel cell device, and/or in parallel with glucose sensor to determine the glucose to lactate ratio for cancer and other metabolic related diseases (tissue damage, tumor growth, heart condition/failure, hypoxia).

Cloning and Overexpression

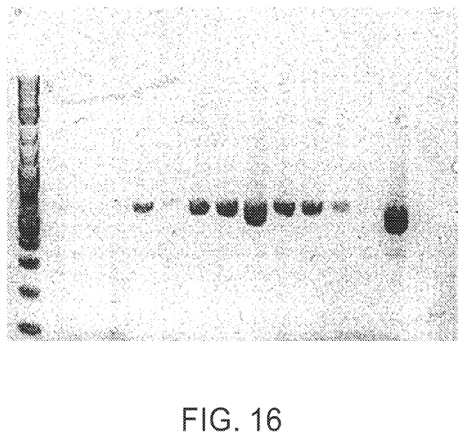

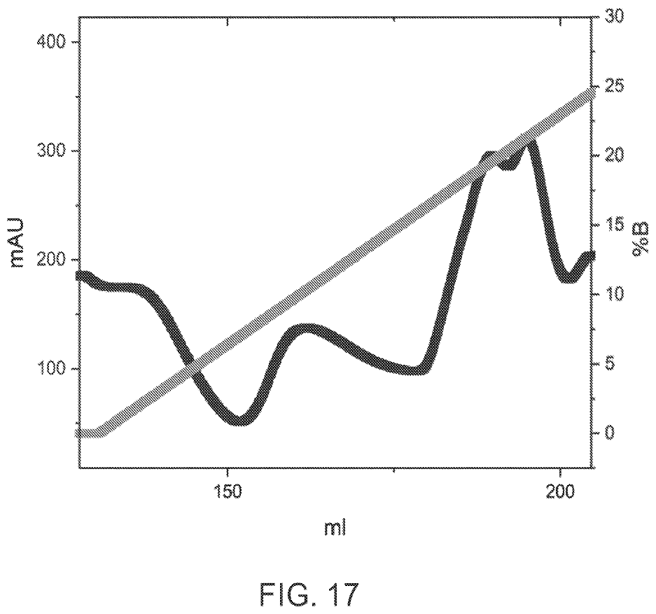

The L-lactate dehydrogenase gene from Saccharomyces cerevisiae (ScLDHNS) was externally synthesized and cloned into pET29b (Twist Bioscience) using the sequence from entry X03215.1 (genebank) after codon optimization and signal peptide removal. Competent E. coli BL-21 (DE3) cells were transformed with pET29ScLDHNS and negatively selected using kanamycin agar plates. Surviving colonies were positively selected via colony PCR, which gave bands of −′500 bp (FIG. 16). For TeGDH overexpression, a 50 ml LB starter of BL21DE3/pET29ScLDH was inoculated with 50 μg/ml Kanamycin and then incubated at 37° C., 180 RPM, overnight. The entire starter was mixed into a 1 L Erlenmeyer flask containing 500 ml Terrific Broth (without glycerol), which was inoculated with 50 μg/ml Kanamycin and then incubated at 37° C., 180 RPM, overnight. The entire starter was mixed into a 1 L Erlenmeyer flask containing 500 ml Terrific Broth (without glycerol), which was inoculated with 50 μg/ml kanamycin, 1 mM MgCl, 1 mM CaCl, and 10 mM glucose. The cells were further incubated at 37° C., 180 RPM for approximately 7 hours. Then, the cells were induced with 0.5 mM FeSO₄ and 500 μl 0.1M IPTG for 18-20 hours of incubation while stirred at 25° C. The cells were centrifuged and the pellet was kept at −80° C. ScLDH cells from a frozen tube were resuspended in 20 ml lysis buffer (50 mM Kpi pH 7.5, 50 mM KCl, 1 mM DL-lactate, 0.1 mM DTT) and disrupted by ultrasonication (30% amplitude, 15 sec on 30 sec off, 11 minutes total on). Removal of cell debris was performed by centrifugation (10,000 g, 30 minutes, 4° C.), after which the supernatant was kept. The clear, pinkish supernatant was passed through the column, which was washed with 5 more column volumes (CVs). The protein was eluted using a linear gradient over 15 CVs from buffer A to buffer B (A—50 mM KPi 7.5 and 50 mM KCl, B—50 mM KPi 7.5 and 1M KCl). The protein began eluting at 20% B (FIG. 17). The protein was further concentrated using 30 kDa centricons at 4° C.

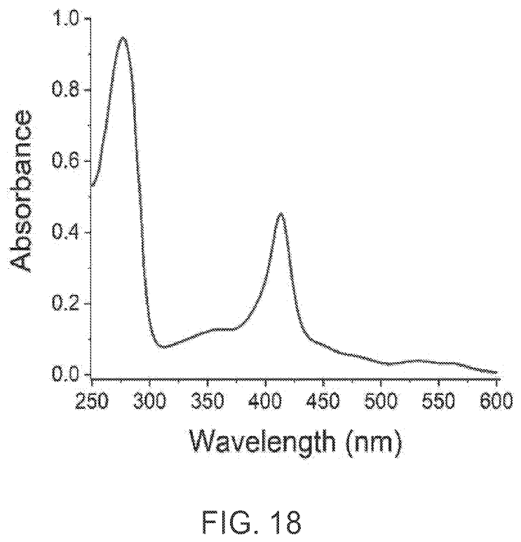

Absorbance spectrum of the concentrated, purified ScLDH is shown in FIG. 18.

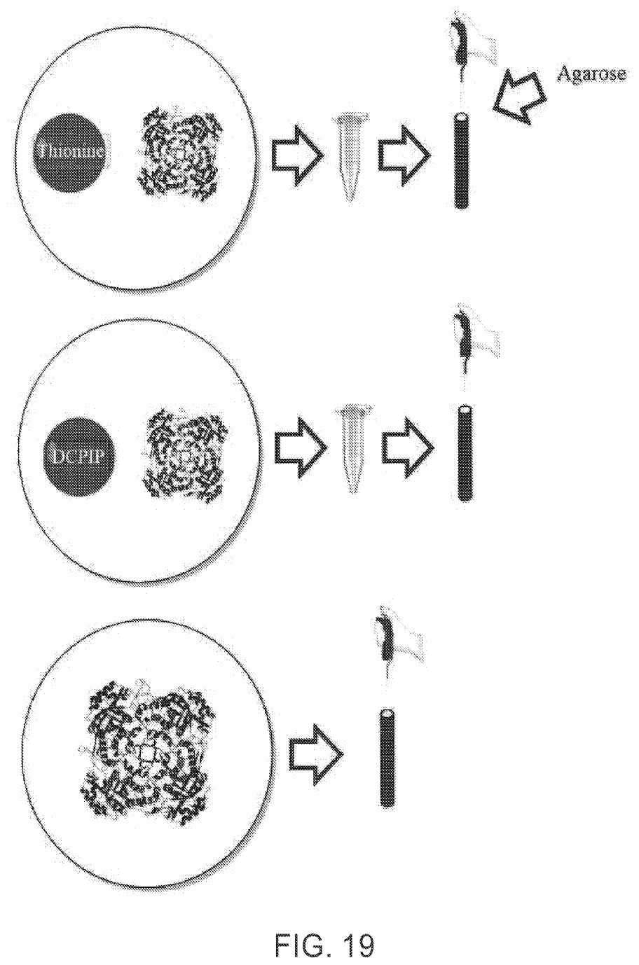

A general scheme for the fabrication of the biosensor is provided in FIG. 19.

Thionine Biosensor Fabrication

2 μl ScLDH 65 μM and 2 μl thionine 20 mM were deposited on a GCE coated with 5 mg/ml MWCNT. After 45 min of drying at RT, 5 μl of agarose 1% were deposited on the GCE, which was then stored at 4°. Each electrode was stored at 4° for at least 30 min before use.

DCPIP Biosensor Fabrication

9 μl ScLDH 65 μM and 1 μl DCPIP 10 mM were deposited on a GCE coated with 5 mg/ml MWCNT, then dried for 45 min at RT.

DET Biosensor Fabrication

5 μl of ScLDH 65 μM were deposited on a GCE coated with 5 mg/ml MWCNT.

Interference Assay

Thionine mediated bioanodes were subjected to CA (0V applied bias) after a five min′ immersion in 0.1 M Kpi pH 7.5. After current stabilization, the following analytes were added to the solution in sequence: 4 mM DL-lactate repeated twice, 0.1 mM Ascorbic acid, 68 μg/ml Uric Acid, 1.1 mM Acetaminophen, 50 mM glucose and 4 mM DL-lactate repeated twice. The measurement was briefly paused before each analyte addition, as to allow homogenization of the solution via pipetting.

Agarose-Thionine Discussion

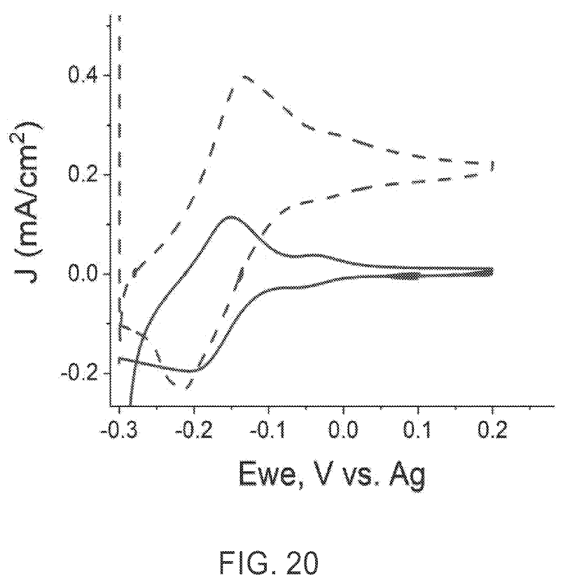

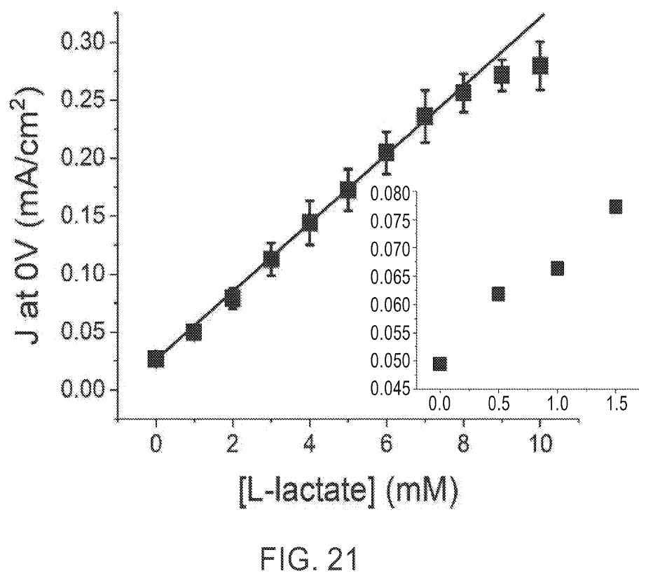

Three configurations of lactate sensor (depicted in FIG. 19) were used. The biosensor may utilize direct or mediated electron transfer (DET and MET respectively) to measure the concentration of L-lactate in a test solution. Though DCPIP could be used to measure lactate, the use of thionine extended the sensing range while lowering the onset potential, FIG. 20. The thionine based configuration allows operation under 0V vs. Ag/AgCl with high bioelectrocatalytic currents. The developed configuration gives linear amperopmetric response in corolating to the addition of L lactate (0-8 mM), FIG. 21.

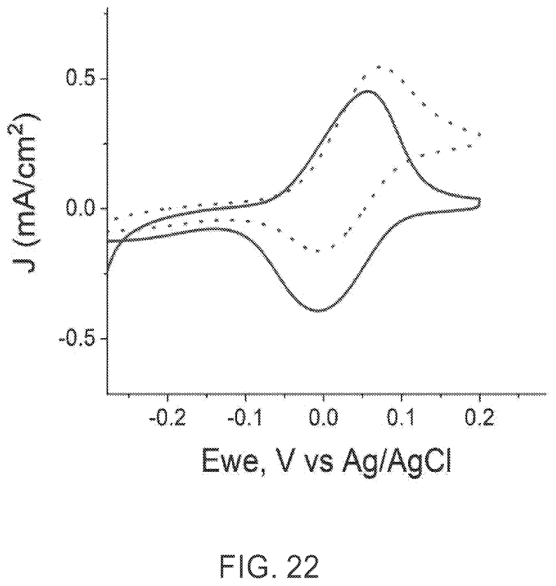

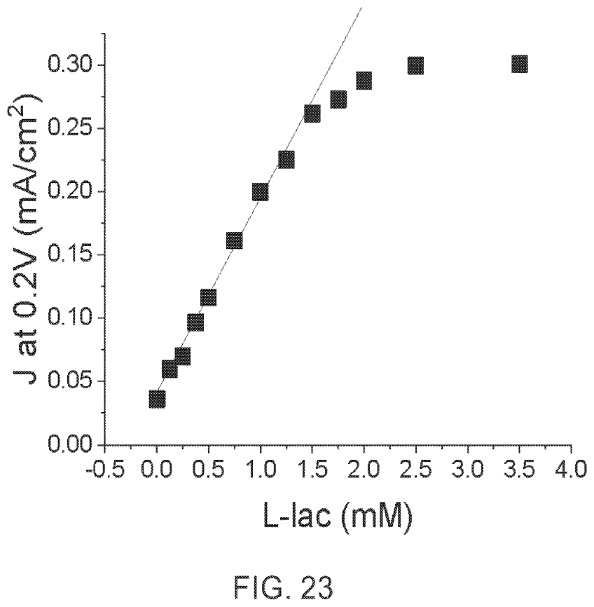

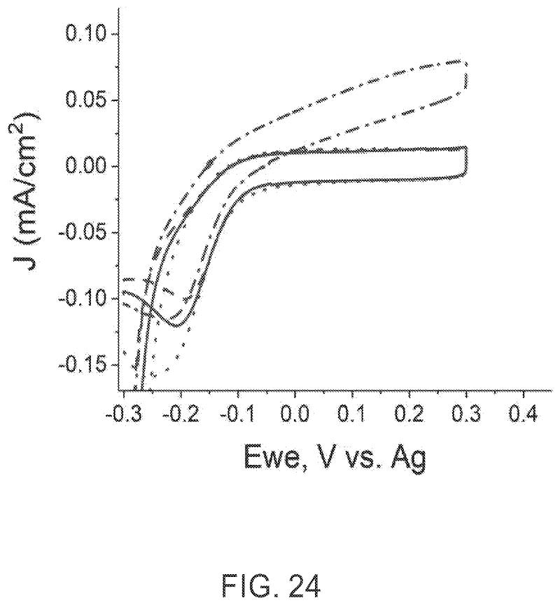

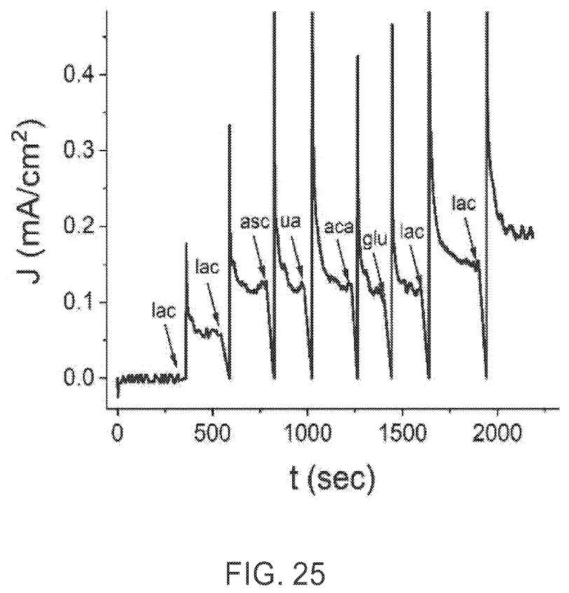

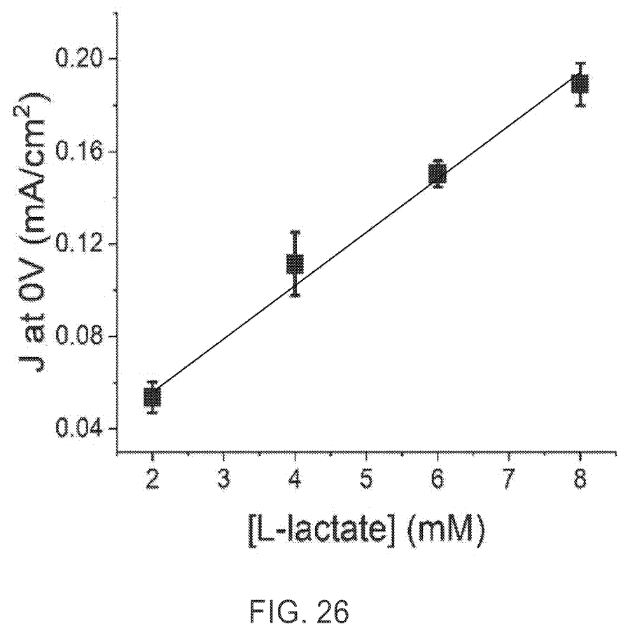

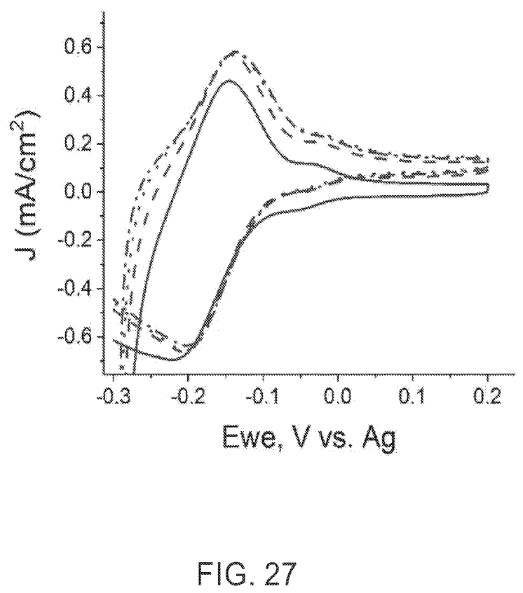

DCPIP was also tested to give a linear response at the range of 0-2 mM under an applied potential of 0.2V, FIG. 22 and FIG. 23, unlike the tested FAD-GDH, the FMN-LDH consisted of both α (FAD cofactor) and β (heme) subunits. Therefore unlike the FAD-GDH the FMN-LDH enable DET activation of the enzyme as depicts in FIG. 24. While using the MET configuration with thionine, the lowered onset potential reduces interferences effects (FIGS. 25 and 26) and potentially generating higher power outputs in biofuel-cell configurations. Also, the average L-lactate levels in the blood range from 0.5 to 1.5 mM, a range that is covered by both MET biosensors. Higher lactate concentrations may result from illnesses such as cancer, heart conditions, hypoxia, lactic acidosis and large-scale tissue damage, thus emphasizing the importance of lactate sensing. By overexpressing the a subunit of FMN-LDH (catalytic domain of ScLDH), DET could not be obtained, however similar bioelectrocatalytic currents were obtained while thionine were used as a redox mediator, FIG. 27.

Biofuel Cell Device

Biosensor construction and measurement GCEs were polished with 1 μm and 0.05 μm alumina beads in a sequence. A suspension of MWCNTs (5 mg/ml) was prepared by dissolving MWCNTs in DMF, followed by a 30 minutes sonication. Afterward, 5 μl of the MWCNTs solution were deposited on a GCE, which was subsequently dried in vacuo for 30 minutes. For DCNQ-based bioanode fabrication, 10 μl of 10 mM DCNQ solution was deposited on the MWCNTs modified GCE and dried in vacuo for 30 minutes. Then, 15 μl of a mixture containing 50 mM TRIS/HCl pH 8.5, 2.75 mg/ml TeGDH, and 0.6 mg/ml dopamine, which was pre-incubated for 30 minutes at room temperature, was deposited on the electrode. The modified GCEs were further incubated for 90 minutes at room temperature. For DCPIP-based bioanodes, 5111 of a mixture containing 50 mM TRIS/HCl pH 8.5, 2.75 mM DCPIP, 2.75 mg/ml TeGDH and 0.6 mg/ml dopamine, which was pre-incubated for 30 minutes at room temperature, was deposited on the electrodes. The modified electrodes were further incubated for one hour at RT. For ABTS mediated BOD biocathodes, a 5 μl mixture containing 50 mM TRIS/HCl pH 8.5, 0.8 mg/ml BOD, 120 μM ABTS, and 66 μg/ml dopamine was deposited on GCE modified with MWCNTs (as described above), which was then incubated for one hour at RT. For activity and saturation curve measurements, the DCPIP or DCNQ based bioanodes were incubated in 20 ml Kpi 0.1 M pH 7 for five minutes, then measured via CV (from −0.3V to 0.2V vs. Ag/AgCl, 5 mV/s). The electrodes were measured without analyte, as well as under increasing glucose concentration. CV measurements were taken a minute after glucose addition. DCNQ based bioanodes were tested using chronoamperometry (CA) at 0V vs. Ag/AgCl. Prior, the electrodes were immersed in 0.1 M Kpi pH 7 for five-minute. After current stabilization, the following analytes were added to the solution in sequence: 68 μg/ml Uric Acid, 2.5 mM glucose repeated four times, 0.1 mM Ascorbic acid, 1.1 mM Acetaminophen and 5 mM glucose repeated twice. The solution was homogenized via pipetting during a brief pause in the measurement. GCE-DCNQ-TeGDH stability measurements were followed via CA (0V vs. Ag/AgCl) in 20 ml 0.1 M Kpi pH 7 for ˜24 hours. After 14 hours, 10 mM glucose was added, and the measurement continued for 10 additional hours.

EBFC measurement. A DCNQ-based bioanode and a biocathode were prepared as mentioned above and placed inside a triple-necked flask filled with 15 ml KPi 0.1 M pH 7. The cell was measured via linear sweep voltammetry (59-sec hold, 2 mV/s, from 0 to 0.5V vs. EOC) using the biocathode as a reference. The measurement was taken under atmospheric conditions and O₂ enrichment.

Results and Discussion. The TeGDH sequence was cloned into pET29b, after which it was overexpressed in E. coli and purified using affinity and gel filtration columns. The protein was then concentrated to 11 mg/ml and its activity was determined. KM and kcat were calculated to give values of 17.5 mM and 886 sec-1, respectively. These results are in the agreement with previous findings. By following the spectral absorbance of the protein and the FAD cofactor in the UV/Vis range, it was estimated that 93.5% of the purified enzymes were active. Using the purified enzyme as a biocatalyst for glucose oxidation, an amperometric biosensing device was constructed, as depicted in FIG. 1. For that, the glassy carbon electrodes (GCE) were modified with multi-walled carbon nanotubes (MWCNT). The MWCNTs increase the practical surface area by a factor of 14.3. Then, a mixed solution of the TeGDH, 2,6-dichlorophenolindophenol (DCPIP), and dopamine were pre-incubated for 30 minutes and then deposited on the GCE-MWCNT surface. The dried electrode was then tested for activity by following the bioelectrocatalytic currents in the absence or presence of glucose. By plotting the achieved bioelectrocatalytic current vs. the increased glucose concentration, a linear correlation could be obtained in the range of 0-20 mM glucose, which is the desired detection range for a diabetic patient. By depositing the purified TeGDH on a MWCNT electrode, low bioelectrocatalytic currents could be measured at a high overpotential of 0.4V vs. Ag/AgCl. While DCPIP enables the efficient MET process, lower potentials are advantageous for either sensing or BFC devices. To reach lower potentials, DCPIP was replaced with redox mediators consisting of more negative potential such as methylene blue, anthraquinone sulfonate, and DCNQ. While the potential of all tested redox molecules could thermodynamically mediate the electron transfer process between the flavin active site and the electrode, only DCNQ enabled efficient bio-electrocatalytic currents with an onset potential at ˜−0.2V. The Thionine molecule was also tested as a redox mediator. While the molecule has a structural similarity to Methylene Blue, it facilitated bioelectrocatalytic currents that are similar to DCNQ. DCNQ has low solubility in an aqueous solution and has a redox potential that is 200 mV more negative than DCPIP. These are advantageous for the long-term stability of future constructed devices and therefore DCNQ was chosen as the redox mediator for the TeGDH based bioanodes.

The DCNQ-based configuration was further characterized, and both redox mediator and enzyme content were analyzed. The DCNQ redox mediator amount was determined to be ˜0.78 nmole while the protein content was 2 nmole. The stability of the designed MWCNTs/GDH/DCNQ biosensor was examined. Chronoamperometry measurements at 0V vs Ag/AgCl were applied while 10 mM of glucose was present in the test solution. The generated bioelectrocatalytic current was stable with a systematic 22% drop for over 14 h. The bioanode's long-term bioelectrocatalytic activity was also examined by the addition of a second glucose dose to the test solution. A current jump coincides with the second addition of glucose, yet with lower intensity. Measurements of interference caused by biomarker molecules similar to the analyte are a key problem that needs to be addressed in any amperometric biosensors device. Therefore, it was possible to examine the TeGDH based bioanode amperometric response while chemicals such as ascorbic acid, uric acid, and acetaminophen were present. The measurement revealed a small change in the biosensor's sensing capability, though a slight deviation was found at 20 mM glucose. This agrees with both the Michaelis-Menten curve and the literature. It should be noted that no bioelectrocatalytic currents were measured without the presence of the TeGDH enzyme using only MWCNTs, DCNQ, and polydopamine. While test strips are a common methodology used by patients to regulate their glucose concentration, continuous glucose monitoring devices are the present and the future of glucose regulation. These biosensing devices operate in the interstitial fluid layer, therefore the designed configuration was examined under a fluid that simulates the human intrastetial fluid (ISF). As expected, lower bioelectrocatalytic currents were observed due to interactions with BSA proteins and high salts, nevertheless, the sensor was active and enabled glucose-sensing without any additional coating step. Besides biosensing applications, the developed bioanode can be utilized in EBFC applications. The FAD-GDH enzyme has an advantage as compared to GOx based devices due to its oxygen-independent catalytic activity. In recent years, several FAD-GDH based biofuel cells (BFCs) were introduced. The oxygen insensitivity is a major advantage in biofuel cell devices, as it prevents short circuit reaction of the oxygen in both bioanode and biocathode. For example, BFC devices were constructed using electropolymerization techniques, nanoporous gold, redox polymers, and osmium complexes bonded to polymeric chains. While major advances have been reached, for practical applications, a simple, low-cost construction methodology should be further realized.

An EBFC was fabricated using bilirubin oxidase (BOD) from M. verrucaria as a biocatalyst for the biocathode. PDA was used as a scaffold polymeric layer to immobilize the BOD together with the ABTS redox mediator, as was recently shown. TeGDH based bioanode and BOD-based biocathode were then conjugated through an external circuit to form an EBFC device. Using a polarization curve, the power output generated could be examined and further characterized under both atmospheric conditions and O₂ saturation. Compared to previously published work with TeGDH, the presented EBFC has reached higher power outputs. The maximal power reached 63 μW/cm² under atmospheric conditions which are 30 times higher than previously reported. By examining the cell under oxygen saturated conditions, a power output of 270 μW/cm² was reached. The potential difference between the bioanode and the biocathode has reached 720 mV, which is dictated by the difference between DCNQ and ABTS redox potentials.

The designed biosensor possessed a good linear response in the range between 0 to 20 mM. This range is mandatory for any future applications toward CGM devices. The biosensor exhibits good stability for at least 24 hours. The use of a programmed electronic device that can correct a current drop may be utilized. By comparing the cloned TeGDH enzyme with other FAD-GDHs that are available for commercial applications (e.g. A. Sp. from Sekisui Diagnostics), a similar stability and bioelectrocatalytic activity could be archived. While these results are promising, genetic manipulation or directed evolution techniques might lead to improved results in terms of enzyme stability or turnover rate. By comparing the obtained TeGDH based bioanode results with a TeGDH bioanode lacking redox mediators, we can conclude that in our configuration, only MET can establish efficient electrical communication with the enzyme. The strong π-π interactions of DCNQ, TeGDH and polydopamine with the MWCNTs allows improved stability. Moreover, the power output using MET was higher than DET due to a better ET process and lower overpotential. The PDA-based configuration yielded improved currents, thus showing its advantage over DET with the presented methodology. The bioanode remained stable for over 20 h of operation, and spiking the sensor with additional glucose amounts revealed that the sensor is still active and responsive. The effect of interferents was also examined and was found to be negligible. This was indeed expected, as the low voltage applied in the developed configuration should not lead to the oxidation of interferents. It should be noted that a linear response to low glucose concentrations at the range of 1 to 5 mM was obtained (using the Aspergillus. sp. variant). This could be an important range in cases of hypoglycemia. The biosensor was shown to function on Toray paper as well, whose low costs and porous structure make it attractive for applicative uses. While sensing of an important biomarker like glucose is extremely important, a multi-sensor capable of simultaneous, varied biomarker sensing will have a bigger impact on human health. It may also provide a valid platform for physicians, providing a fast point of care results with a wide scope that should allow better treatment. The developed EBFC has led to a maximal power output of 270 μW/cm².

1-39. (canceled)

40. An oxygen-passive electrode having a surface region composed of at least one carbon allotrope associated with a layer of a matrix material, the layer entrapping at least one enzyme and at least one redox charge mediator.

41. An oxygen-passive biosensor device comprising at least one electrode having a surface region composed of at least one carbon allotrope, the surface region being associated with a matrix material entrapping at least one enzyme and at least one redox charge mediator.

42. The biosensor according to claim 41, wherein the at least one enzyme and at least one redox mediator are confined to a molecular film of the matrix material.

43. The biosensor according to claim 41, wherein the carbon allotrope having a surface area between 120 and 1315 m2/gr.

44. The biosensor according to claim 41, wherein the carbon allotrope is selected from carbon nanotubes, graphite, carbon paste, fullerenes, carbon nanobuds, amorphous carbon, glassy carbon, lonsdaleite and carbon nanofoam.

45. The biosensor according to claim 44, wherein the electrode is a glassy carbon electrode (GCE) and the carbon allotrope is carbon nanotube.

46. The biosensor according to claim 41, wherein the matrix material is a polymeric material or a polyscharide, or wherein the matrix material is selected from polydopamine, agarose, Nafion, chitosan, polyethyelenimine (PEI) and polyvinylpyridine (PVPy).

47. The biosensor according to claim 46, wherein the matrix material is polydopamine or agarose.

48. The biosensor according to claim 41, the device being an oxygen-passive biosensor device comprising a surface region of a carbon allotrope and polydopamine as a matrix material layer, associated with said surface region, the polydopamine matrix material layer entrapping at least one enzyme and at least one redox charge mediator, or wherein the device is an oxygen-passive biosensor comprising a surface region of a carbon allotrope and agarose as a matrix material layer, associated with said surface region, the agarose matrix material layer entrapping at least one enzyme and at least one redox charge mediator.

49. The biosensor according to claim 41, wherein the at least one redox charge mediator is selected from substituted naphthoquinones, or from benzyl viologen, indigo disulfonate, methylene blue, 2,5-dihydroxybenzoquinone, ferrocenecarboxaldehyde, ferrocenmethanol, dichloronaphtoquinone (DCNQ) and dichlorophenol indo-phenol (DCPIP).

50. The biosensor according to claim 49, wherein the redox charge mediator is dichloronaphtoquinone (DCNQ) or dichlorophenol indo-phenol (DCPIP).

51. The biosensor according to claim 41, wherein the at least one enzyme is selected from glucose dehydrogenase (GDH), lactate dehydrogenase (LDH), lactose dehydrogenase, alcohol dehydrogenase, fructose dehydrogenase and glucose-6-phosphate dehydrogenase.

52. The biosensor according to claim 41, being a glucose sensor.

53. The biosensor according to claim 52, wherein the at least one enzyme is glucose dehydrogenase (GDH), wherein the GDH enzyme is optionally a nicotinamide-dependent GDH, a pyrroloquinoline quinone (PQQ-GDH) or a flavin adenine dinucleotide (FAD-dependent GDH, FAD-GDH) enzyme.

54. The biosensor according to claim 41, being a lactate sensor.

55. The biosensor according to claim 54, wherein the at least one enzyme is lactate dehydrogenase (LDH), wherein the LDH is optionally a flavin mononucleotide (FMN)-dependent L-LDH.

56. A glucometer oxygen-passive device for detecting presence and/or amount of glucose in a sample, the device comprising an electrode having a surface region comprising or consisting at least one carbon allotrope, the surface region being associated with a polydopamine entrapping FAD-GDH and at least one redox charge mediator.

57. An oxygen-passive biosensor device for detecting presence and/or amount of lactate in a sample, the device comprising an electrode having a surface region comprising or consisting at least one carbon allotrope, the surface region being associated with a polydopamine or agarose entrapping lactate dehydrogenase (LDH) and at least one redox charge mediator.

58. A multi-sensing oxygen-passive device for determining presence of two or more analytes, the device comprising one or more biosensor according to claim 41.

59. An oxygen-passive sensing unit comprising:
an electrode assembly comprising at least one working electrode and at least one reference electrode, the at least one working electrode having an active surface of at least one carbon allotrope and a film of polydopamine disposed thereon, the film of polydopamine comprising, entrapping or holding one or more enzymes and one or more redox charge mediators,
a measuring circuit for measuring a change in the current generated by the working electrode at constant potential, as a function of time, and
a connection means to connect said electrodes to the measuring circuit,
the device being configured and operable for functioning when in contact with a medium to be analyzed.
